(19) United States
(12) Patent Application Publication
(10) Pub. No.: US 2006/0061567 A1
(43) Pub. Date: Mar. 23, 2006

(54) Program, information storage medium and image generation apparatus

(75) Inventor: Satoru Ouchi, Yokohama-shi (JP)

Correspondence Address: OLIFF & BERRIDGE, PLC, P.O. BOX 19928, ALEXANDRIA, VA, 22320, US

(73) Assignee: NAMCO LTD., Tokyo (JP)

(21) Appl. No.: 11/227,123

(22) Filed: Sep. 16, 2005

(30) Foreign Application Priority Data
Sep. 22, 2004 (JP) 2004-275493

(51) Int. Cl. G06T 15/00

(52) U.S. Cl. 345/419

(57) ABSTRACT

A program for making a computer generate a space image including a moving body moving in a virtual 3D space based on a visual point, makes the computer function as: a visual point control unit controlling the visual point according to movement of the moving body so that the moving body is arranged at a predetermined position in the space image; a background image generation unit generating an image in the 3D space except for the moving body as a background image based on the visual point; a blur processing unit performing predetermined blur processing to the generated background image to generate a background blur image; a moving body image generation unit generating a moving body image based on the visual point; and a space image generation unit synthesizing the generated moving body image and the background blur image generated by the blur processing unit to generate the space image.

### BACKGROUND OF THE INVENTION

1. Field of the Invention

The present invention relates to an image generation apparatus which generates a space image including a moving body moving in a virtual three-dimensional space based on a given visual point, and the like.

2. Description of Related Art

An image generation apparatus such as a game apparatus which generates an image including a moving body moving in a virtual three-dimensional space is known. In such an image generation apparatus, a technique of performing blur processing with an object of producing the speediness feeling (feeling of speed) of the moving body is known. The blur processing is the visual effect processing for reproducing a state in which a moving body is photographed with a blur in a real world.

As the blur processing, for example, (1) there is a method of expressing the blur by synthesizing (e.g. semitransparent synthesis) the images of preceding frames (one to several frames) and a still image of the present frame. Moreover, as another blur processing, (2) there is a method of performing the semitransparent synthesis (e.g. a synthesis) of images produced by shifting a still image of the present frame little by little (e.g. one to several pixels) to the still image of the present frame.

Incidentally, although it differs from the blur processing, as a technique for expressing the speediness feeling of a moving body object, a technique applied when a visual point is set so as to follow a moving body object is disclosed in JP-3442736B. In such a technique, a visibility clear region is set at the center of an image based on a visual point, and degrading processing is performed to the regions other than the visibility clear region. The speediness feeling of the moving body object can be expressed by narrowing the visibility clear region as the movement speed of the moving body object rises.

However, by the method of the blur processing mentioned above, the following inconveniences have been arisen when the image of a moving body, especially moving at a high speed, is generated.

That is, (1) by the method of synthesizing the images of previous frames, as the speed of a moving body becomes faster, the positional change of the moving body in the image of each frame became larger. Consequently, the intervals of the “afterimages” of the displayed moving body become longer to be “discontinuous”, and the “after images” become unnatural images which are not real. Moreover, the method needs a certain memory capacity for storing each image to be synthesized temporarily.

Moreover, (2) by the method of shifting images to perform semitransparent synthesis, a blur is produced on the whole image. Consequently, the blur is produced on all the objects photographed in the images such as trees and buildings as well as the moving body, and the synthesized image becomes unnatural image which is not real.

For example, in the case where a visual point is set in order that a sight line direction always faces the moving body, such as the case where the position of the visual point is fixed and the posture of the visual point is changed (for example, corresponding to the so-called “panning” of performing pan) or the case where the relative distance and the relative posture of the visual point to the moving body are fixed and the position of the visual point is changed (namely, the visual point is made to follow the moving body), because the position and the posture of the moving body in a rendered image hardly change, no blur is produced on the moving body. Consequently, it is desirable that the image becomes one in which blurs are produced only on the background and the like except for the moving body. Moreover, in the case where the position and the posture of the visual point are fixed and the speediness feeling of the moving body is tried to be expressed, it is preferable to form a rendered image in which a blur is produced only on the moving body, the relative position of which to the visual point changes, and no blur is produced on the background and the like, the relative positions of which to the visual point do not change (like an image photographed at a low shutter speed).

### SUMMARY OF THE INVENTION

In view of the situation mentioned above, it is an object of the present invention to distinguish an object to be an object of blur processing from an object not to be an object of the blur processing, and to generate a real image with an abundance of speediness feeling.

In order to solve the problems mentioned above, in accordance with the first aspect of the present invention, a program (for example, a game program 410 in FIG. 10) for making a computer generate a space image including a moving body (for example, a moving body 10 in FIG. 3) moving in a virtual three-dimensional space based on a given visual point (for example, a virtual camera 30 in FIG. 3) makes the computer function as

a visual point control unit (for example, a virtual camera control unit 213 in FIG. 10, and a process at Step S13 in FIG. 14) for controlling the visual point according to a movement of the moving body so that the moving body is arranged at a predetermined position in the space image;

a background image generation unit (for example, a background image generation unit 131 in FIG. 10, and processes at Steps T11-T12 and T16 in FIG. 15) for generating an image in the virtual three-dimensional space except for the moving body as a background image based on the visual point;

a blur processing unit (for example, a background blur processing unit 133 in FIG. 10, and processes at Steps T13 and T17 in FIG. 15) for performing predetermined blur processing to the generated background image to generate a background blur image;

a moving body image generation unit (for example, a moving body image generation unit 135 in FIG. 10, and a process at Step T14 in FIG. 15) for generating an image of the moving body based on the visual point; and

a space image generation unit (for example, an image synthesis unit 137 in FIG. 10, and processes at Steps T15 and T18 in FIG. 15) for synthesizing the generated image of the moving body and the background blur image generated by the blur processing unit to generate the space image.

In accordance with the second aspect of the present invention, an image generation apparatus (for example, a household game apparatus 1200 in FIGS. 1 and 10) for generating a space image including a moving body moving in a virtual three-dimensional space based on a given visual point includes

a visual point control unit (for example, the virtual camera control unit 213 in FIG. 10) for controlling the visual point according to a movement of the moving body so that the moving body is arranged at a predetermined position in the space image;

a background image generation unit (for example, the background image generation unit 131 in FIG. 10) for generating an image of the virtual three-dimensional space except for the moving body as a background image based on the visual point;

a blur processing unit (for example, the background blur processing unit 133 in FIG. 10) for performing predetermined blur processing to the generated background image to generate a background blur image;

a moving body image generation unit (for example, the moving body image generation unit 135 in FIG. 10) for generating an image of the moving body based on the visual point; and

a space image generation unit (for example, the image synthesis unit 137 in FIG. 10) for synthesizing the generated image of the moving body and the background blur image generated by the blur processing unit to generate the space image.

According to the first or second aspect of the invention, in the generation of a space image including a moving body moving in a virtual three-dimensional space, a visual point is controlled according to the movement of the moving body in order that the moving body is displayed at a predetermined position in the space image. And, a background blur image is generated by performing predetermined blur processing to an image of the virtual three-dimensional space except for the moving body (background image) generated based on the visual point. Then, the image of the moving body generated based on the visual point is synthesized with the background blur image, and the space image is generated. Consequently, it is possible to generate the real space image of the moving body with an abundance of speediness feeling in which no blur is produced on the moving body (the position and the posture thereof hardly change) arranged at the predetermined position in the image and blurs are produced only on the background and the like except for the moving body.

Preferably, the program makes the computer function in order that the direction control unit includes a sight line direction control unit (for example, a virtual camera control unit 213 in FIG. 10, and Step S13 in FIG. 14) for controlling a sight line direction of the visual point to face the moving body, and

the blur processing unit perform the blur processing by varying a blur direction based on a change of the sight line direction controlled by the sight line direction control unit.

According to this invention, a visual point is controlled in order that the sight line direction thereof may face a moving body, and blur processing is performed by varying a blur direction based on a change of the sight line direction. In the case where the visual point is set in order that the sight line direction may face the moving body, the change direction of the sight line direction becomes a direction along the movement direction of the moving body, and the relative positional change direction of the background and the like except for the moving body to the visual point becomes a direction along the reverse direction of the change direction of the sight line direction. For this reason, it is possible to generate a more natural space image in which blurs are produced on the background and the like in the direction reverse to the movement direction of the moving body by setting the blur direction to, for example, the direction reverse to the change direction of the sight line direction.

Preferably, the program makes the computer function in order that the blur processing unit generates the background blur image by synthesizing a reproduction of the generated background image into a direction reverse to a change direction of the sight line direction controlled by the sight line direction control unit

According to this invention, a background blur image is generated by shifting a reproduction of a background image into a direction reverse to the change direction of the sight line direction while synthesizing the reproduction and the background image. Consequently, it is possible to generate a more natural space image in which a blur is produced on the background and the like except for the moving body in the direction reverse to the movement direction of the moving body.

Preferably, the program makes the computer function in order that the blur processing unit further performs the blur processing by varying a degree of a blur based on a variation of the sight line direction controlled by the sight line direction control unit.

According to this invention, the degree of a blur is varied based on a variation of a sight line direction, and blur processing is performed. In the case where a visual point is set in order that the sight line direction may face a moving body and, for example, the moving body moves to pass the front of the visual point, the variation in the sight line direction becomes larger as the relative movement speed of the moving body to the visual point is faster. Accordingly, it is possible to generate a space image expressing the speediness feeling of the moving body more effectively by enlarging (strengthening) the degrees of the blur as the variation of the sight line direction of the visual point is larger.

Preferably, the program makes the computer function in order that the visual point control unit includes a following control unit for controlling the visual point so as to follow the moving body; and

the blur processing unit performs the blur processing by varying a blur direction based on a direction of a positional change of the visual point by the following control unit.

According to this invention, a visual point is controlled to follow a moving body, and a blur direction is varied based on the direction of the positional change of the visual point while blur processing is performed. In the case where the visual point is set in order to follow the moving body, the positional change direction of the visual point nearly agrees with the movement direction of the moving body, and the relative positional change direction of a background and the like except for the moving body to the visual point becomes the direction reverse to the positional change direction of the visual point. For this reason, it is possible to generate a more natural space image in which blurs are produced on the background and the like in the reverse direction to the movement direction of the moving body by setting the blur direction to the reverse direction to the change direction of the sight line direction.

Preferably, the program makes the computer function in order that the blur processing unit generates the background blur image by synthesizing a reproduction of the generated background image by shifting into a direction reverse to the direction of the positional change of the visual point by the following control unit.

According to this invention, a blur image is generated by shifting a reproduction of a background image into a direction reverse to the change direction of the sight line direction while synthesizing the reproduction and the background image. Consequently, it is possible to generate a space image in which blurs are produced on the background and the like except for the moving body in the direction reverse to the movement direction of the moving body.

Preferably, the program makes the computer function in order that the following control unit controls the visual point so as to follow the moving body from a rear of a movement of the mobbing body; and

the blur processing unit generates the background blur image by synthesizing reproductions of the generated background image by shifting the reproductions in order into a direction reverse to the direction of the positional change of the visual point by the following control unit, and by synthesizing the reproductions while enlarging sizes of the reproductions as the shifting is performed more times.

According to this invention, a visual point is controlled to follow a moving body from the rear of the movement of the moving body, and a reproduction of a background image is shifted into the direction reverse to the direction of the positional change of the visual point while the reproduction is synthesized with the background image. Moreover, the size of the reproduction is made to be larger as the reproduction is more shifted. Thereby, a background blur image is generated. In the case where the visual point is set to follow the moving body from the rear of the movement of the moving body, the positional change direction of the visual point and the movement direction of the moving body nearly agree with each other. Consequently, the positional change direction of the background in a space image becomes the direction reverse to the positional change direction of the visual point. Consequently, it is possible to generate the space image in which blurs are produced so that the background and the like flow into the “foreground”. Moreover, because a background and the like are displayed in the way in which the background and the like become larger as they flow into the “foreground” by enlarging the size of the reproduction of the background image as the reproduction is more shifted to be synthesized with the background image. Consequently, it is possible to generate a more natural space image expressing perspective as well as speediness feeling.

Preferably, the program makes the computer function in order that the blur processing unit further performs the blur processing by varying a degree of a blur based on the variation of the position of the visual point by the following control unit.

According to this invention, the degree of a blur is varied based on a variation of the position of a visual point, and blur processing is performed. In the case where the visual point is controlled to follow a moving body, the variation of the position of the visual point becomes one being nearly in proportion to the movement speed of the moving body. That is, as the movement speed of the moving body is faster, the variation of the position of the visual point becomes larger. Consequently, for example, by enlarging (strengthening) the degree of the blur as the variation of the position of the visual point is larger, it is possible to generate a space image expressing speediness feeling of the moving body more effectively.

Preferably, a program makes a computer function in order that

the background image generation unit includes:

a rear background image generation unit (for example, the background image generation unit 131 in FIG. 10, and the process at Step T12 in FIG. 15) for generating an image of the virtual three-dimensional space in a rear of the moving body as seen from the visual point as a rear background image, and

a front background image generation unit (for example, the background image generation unit 131 in FIG. 10, and the process at Step T16 in FIG. 15) for generating an image of the virtual three-dimensional space in a front of the moving body as seen from the visual point as a front background image; and that

the blur processing unit includes

a rear blur processing unit (for example, the background blur processing unit 133 in FIG. 10, and the process at Step S13 in FIG. 15) for performing the blur processing to the generated rear background image to generate a rear background blur image, and

a front blur processing unit (for example, the background blur processing unit 133 in FIG. 10, and the process at Step S17 in FIG. 15) for performing the blur processing to the generated front background image to generate a front background blur image; and further that

the space image generation unit synthesizes the generated image of the moving body and the generated rear background blur image, and further synthesizes the generated front background blur image and the synthesized image to generate the space image.

According to this invention, as background images, an image (rear background image) of a virtual three-dimensional space in the rear of a moving body as seen from a visual point and an image (front background image) of a virtual three-dimensional space in the front of the moving body as seen from the visual point are generated, and predetermined blur processing is performed to each of the rear background image and the front background image to generate a rear background blur image and a front background blur image, respectively. Then, the image of the moving body is synthesized with the rear background blur image, and the front background blur image is synthesized with the synthesized image to generate a space image.

In the case where a part or the whole of the moving object is shielded by an object located in the foreground of the moving body as seen from the visual point, the blur processing is performed to the image (background image) in the whole virtual three-dimensional space except for the moving body, and the image of the moving body is synthesized with the processed image. In such a case, there is produced an inconvenience that the shielding object is not displayed in the foreground of the moving body in the generated space image but the shielding object is displayed in the rear of the moving body to be hidden by the moving body. Accordingly, like this invention, the background image is generated by dividing the background image into the rear background image and the front background image, and the blur processing is performed to each of the background images to synthesize the processed image and the moving body image. Thereby, the shielding object is displayed in the foreground of the moving body to shield the moving body, and it is possible to generate a natural space image in which a blur is produced on the shielding object similarly to the other objects in the background.

In accordance with the third aspect of the invention, a program (for example, the game program 410 in FIG. 23) for making a computer generate a space image including a moving body (for example, the moving body 10 in FIG. 3) moving in a virtual three-dimensional space based on a visual point (for example, the virtual camera 30 in FIG. 3) the sight line direction and the arrangement position of which is previously set makes the computer function as:

a moving body image generation unit (for example, the moving body image generation unit 135 in FIG. 23, and the process at Step T23 in FIG. 27) for generating an image of the moving body as a moving body image based on the visual point;

a blur processing unit (for example, a moving body blur processing unit 136 in FIG. 23, and the process at Step T24 in FIG. 27) for performing predetermined blur processing to the generated moving body image to generate a moving body blur image;

a rear background image generation unit (for example, the background image generation unit 131 in FIG. 23, and the process at Step T22 in FIG. 27) for generating an image of the virtual three-dimensional space in a rear of the moving body as seen from the visual point as a rear background image;

a front background image generation unit (for example, the background image generation unit 131 in FIG. 23, and the process at Step T26 in FIG. 27) for generating an image of the virtual three-dimensional space in a front of the moving body as seen from the visual point as a front background image; and

a space image generation unit (for example, an image synthesis unit 138 in FIG. 23, and the processes at Steps T25 and T27 in FIG. 27) for synthesizing the generated moving body blur image and the generated rear background image, and further synthesizing the generated front background image and the synthesized image to generate the space image.

In accordance with the fourth aspect of the present invention, an image generation apparatus (for example, the household game apparatus 1200 in FIGS. 1 and 23) for generating a space image including a moving body moving in a virtual three-dimensional space based on a visual point a sight line direction and an arrangement position of which is previously set includes:

a moving body image generation unit (for example, the moving body image generation unit 135 in FIG. 23) for generating an image of the moving body as a moving body image based on the visual point;

a blur processing unit (for example, a blur processing unit 136 in FIG. 23) for performing predetermined blur processing to the generated moving body image to generate a moving body blur image;

a rear background image generation unit (for example, the background image generation unit 131 in FIG. 23) for generating an image of the virtual three-dimensional space in a rear of the moving body as seen from the visual point as a rear background image;

a front background image generation unit (for example, the background image generation unit 131 in FIG. 23) for generating an image of the virtual three-dimensional space in a front of the moving body as seen from the visual point as a front background image; and

a space image generation unit (for example, the image synthesis unit 138 in FIG. 23) for synthesizing the generated moving body blur image and the generated rear background image, and further synthesizing the generated front background image and the synthesized image to generate the space image.

According to the third or fourth aspect of the invention, in the generation of the space image including the moving body moving in the virtual three-dimensional space, the moving body blur image is generated by performing the predetermined blur processing to the image of the moving body (moving body image) generated based on the visual point the sight line direction and the arrangement position of which have been previously set. Then, the moving body blur image is synthesized with the image (rear background image) of the virtual three-dimensional space in the rear of the moving body generated based on the visual point, and the image (front background image) in the virtual three-dimensional space in the front of the moving body is further synthesized with the synthesized image to generate the space image. Consequently, in the generated space image, the position of the moving body changes, and positions of the background and the like except for the moving body are displayed without changing. Then, it is possible to generate a real space image having an abundance of speediness feeling in which no blur is produced on the background and the like, the positions of which do not change, and a blur is produced on the moving image, the position of which changes.

Moreover, the whole image of the virtual three-dimensional space is generated by dividing the whole image into the image of the three-dimensional space in the rear of the moving body (the rear background image) and the image of the three-dimensional space in the front of the moving body (the front background image), and the respective images are synthesized with the moving body blur image. Thereby, even when an object shielding a part or the whole of the moving body exists in the foreground of the moving body as seen from the visual point, it is possible to generate a natural space image in which the shielding object is displayed in the foreground of the moving body to shield the moving body.

In accordance with the fifth aspect of the present invention is a program (for example, the game program 410 in FIGS. 10 and 23) for making a computer generate a space image including a moving body (for example, the moving body 10 in FIG. 3) moving in a virtual three-dimensional space based on a given visual point (for example, the virtual camera 30 in FIG. 3), the program making the computer function as:

a moving body image generation unit (for example, the moving body image generation unit 135 in FIGS. 10 and 23) for generating an image of the moving body as a moving body image based on the visual point;

a rear image generation unit (for example, the background image generation unit 131 in FIGS. 10 and 23) for generating an image of the virtual three-dimension space in a rear of the moving body as seen from the visual point as a rear background image;

a front image generation unit (for example, the background image generation unit 131 in FIGS. 10 and 23) for generating an image of the virtual three-dimensional space in a front of the moving body as seen from the visual point as a front background image;

a blur processing unit (for example, the background blur processing unit 133 in FIG. 10, or the moving body blur processing unit 136 in FIG. 23) for performing blur processing to at least one image among the generated moving body image, the generated rear background image and the generated front background image; and

a space image generation unit (for example, the image synthesis unit 137 in FIG. 10, or the image synthesis unit 138 in FIG. 23) for synthesizing the generated moving body image and the generated rear background image, and further for synthesizing the generated front background image and the synthesized image to generate the space image, wherein as to the image having received the blur processing by the blur processing unit among the rear background image, the moving body image and the front background image, the image having received the blur processing is synthesized with the other images.

In accordance with the sixth aspect of the invention, an image generation apparatus (for example, the household game apparatus 1200 in FIGS. 1, 10 and 23) for generating a space image including a moving body (for example, the moving body 10 in FIG. 3) moving in a virtual three-dimensional space based on a given visual point (for example, the virtual camera 30 in FIG. 3) includes:

a moving body image generation unit (for example, the moving body image generation unit 135 in FIGS. 10 and 23) for generating an image of the moving body as a moving body image based on the visual point;

a rear image generation unit (for example, the background image generation unit 131 in FIGS. 10 and 23) for generating an image of the virtual three-dimensional space in a rear of the moving body as seen from the visual point as a rear background image;

a front image generation unit (for example, the background image generation unit 131 in FIGS. 10 and 23) for generating an image of the virtual three-dimensional space in a front of the moving body as seen from the visual point as a front background image;

a blur processing unit (for example, the background blur processing unit 133 in FIG. 10, or the moving body blur processing unit 136 in FIG. 23) for performing blur processing to at least an image among the generated moving body image, the generated rear background image and the generated front background image; and

a space image generation unit (for example, the image synthesis unit 137 in FIG. 10, or the image synthesis unit 138 in FIG. 23) for synthesizing the generated moving body image and the generated rear background image, and further for synthesizing the generated front background image and the synthesized image to generate the space image, wherein as to the image having received the blur processing by the blur processing unit among the rear background image, the moving body image and the front background image, the image having received the blur processing is synthesized with the other images.

According to the fifth or sixth aspect of the invention, in the generation of the space image including the moving body moving in the virtual three-dimensional space, the image of the moving body (the moving body image), the image of the virtual three-dimensional space in the rear of the moving body as seen from the given visual point (the rear background image), and the image of the virtual three-dimensional space in the front of the moving body as seen from the given visual point (the front background image) are generated based on the given visual point, and the blur processing is performed to at least one image of the moving body image, the rear background image and the front background image. Then, the moving body image is synthesized with the rear background image, and further the front background image is synthesized with the synthesized image. Thus, the space image is generated. At this time, as for the image having received the blur processing, the image having received the blur processing is synthesized.

Consequently, for example, in the case where the visual point is controlled in order that the moving body may be displayed at a predetermined position in the space image, it is possible to generate a real space image with an abundance of speediness feeling in which no blur is produced on the moving body, the position of which does not change in the image, and blurs are produced only on the background and the like except for the moving body by performing the blur processing to the rear background image and the front background image. Moreover, in the case where the sight line direction and the arrangement position of the visual point have been previously set, it is possible to generate a real space image with an abundance of speediness feeling in which no blurs are produced on the background and the like, the positions of which do not change in the image, and a blur is produced on the moving body, the position of which changes, by performing the blur processing to the moving body image.

Moreover, the whole image of the virtual three-dimensional space is generated by dividing the whole image into the image of the three-dimensional space in the rear of the moving body (the rear background image) and the image of the three-dimensional space in the front of the moving body (the front background image), and the respective images are synthesized with the moving body blur image. Thereby, even when an object shielding a part or the whole of the moving body exists in the foreground of the moving body as seen from the visual point, it is possible to generate a natural space image in which the shielding object is displayed in the foreground of the moving body to shield the moving body.

Furthermore, in accordance with the seventh aspect of the invention, an information storage medium capable of being read by a computer stores any one of the above programs.

Hereupon, the “information storage medium” means a storage medium such as a hard disk, an MO, a CD-ROM, a DVD, a memory card, an IC memory, which stores information capable of being read by a computer. Consequently, according to the seventh aspect of the invention, by making the computer read the information stored in the information storage medium to execute operation processing thereof, it is possible to obtain the similar effects to those of the other aspects of the present invention.

According to the present invention, when a space image including a moving body moving in a virtual three-dimensional space is generated, a natural image in which an object on which a blur is produced and another object on which no blur is produced are distinguished from each other is generated. That is, in the case where a visual point is set in order that the moving body may be displayed at a predetermined position in a space image, the space image in which no blur is produced on the moving body, the position of which does not change, but blurs are produced on a background and the like, the positions of which change, is generated. Moreover, in the case where a visual point the sight line direction and the arrangement position of which are fixed is set, a space image in which a blur is produced on the moving body, the position of which changes in an image, and no blurs are produced on the background and the like, the positions of which do not change in the image, is generated.

Moreover, an image (background image) of a virtual three-dimensional space except for a moving body is generated by dividing the image into an image (rear background image) of the rear space of the moving body as seen from a visual point and an image (front background image) of the front space of the moving body as seen from the visual point, and a space image is generated by synthesizing the background image and a moving body image. Thereby, in the case where there is an object shielding a part or the whole of the moving body in the foreground of the moving body as seen from a visual point, an inconvenience in which the shielding object is displayed so as to be hidden in the rear of the moving body is avoided, and the shielding object is displayed so as to shield the moving body in the foreground of the moving body. That is, a natural space image in consideration of the positional relations of the moving body, the background and the like is generable.

### BRIEF DESCRIPTION OF THE DRAWINGS

The present invention will become more fully understood from the detailed description given hereinbelow and the accompanying drawings which are given by way of illustration only, and thus are not intended as a definition of the limits of the present invention, and wherein:

FIG. 1 is a view showing an example of the external appearance of a household game apparatus to which the present invention is applied;

FIG. 2 is a view showing an example of a game screen in a first embodiment;

FIG. 3 is a view showing an example of a setting of a game space;

FIG. 4 is an explanatory diagram of the coordinate system (camera coordinate system) of a virtual camera;

FIGS. 5A and 5B are explanatory diagrams of a division of a game space;

FIG. 6 is a view showing a generation procedure of a space image in the first embodiment;

FIG. 7 is an explanatory diagram of changes of the sight line direction of a virtual camera;

FIG. 8 is an explanatory diagram of the directions in which an image is shifted based on the changes of the sight line direction of a virtual camera;

FIG. 9 is a view showing a synthesis procedure of an image in blur processing;

FIG. 10 is a functional configuration diagram of the household game apparatus in the first embodiment;

FIG. 11 is a table showing an example of data configuration of moving body movement information;

FIG. 12 is a table showing an example of the data configuration of virtual camera setting information in the first embodiment;

FIG. 13 is a graph showing an example of blur degree setting information in the first embodiment;

FIG. 14 is a flowchart of the whole processing of the first embodiment;

FIG. 15 is a flowchart of image generation processing executed in the processing of FIG. 14;

FIG. 16 is a diagram showing an example of the hardware configuration of the household game apparatus to which the present invention is applied;

FIGS. 17A and 17B are explanatory diagrams in the case where the virtual camera is set in order to follow the rear of the movement of the moving body;

FIGS. 18A and 18B are explanatory diagrams in the case where the virtual camera is set in order to follow the moving body while running parallel to the moving body;

FIG. 19 is a view showing an example of a game screen in a second embodiment;

FIG. 20 is a view showing a generation procedure of a space image in the second embodiment;

FIG. 21 is an explanatory diagram of changes of the positional direction of a moving body in the inside of an image;

FIG. 22 is an explanatory diagram of the directions in which an image is shifted based on the changes of the positional direction of the moving body in the image;

FIG. 23 is a functional configuration diagram of a household game apparatus in the second embodiment;

FIG. 24 is a table showing an example of the data configuration of virtual camera setting information in the second embodiment;

FIG. 25 is a graph showing an example of blur degree setting information in the second embodiment;

FIG. 26 is a flowchart of the whole processing in the second embodiment;

FIG. 27 is a flowchart of image generation processing executed in the processing of FIG. 26;

FIGS. 28A, 28B and 28C are explanatory diagrams in the case of enlarging an object image and executing blur processing;

FIGS. 29A, 29B and 29C are explanatory diagrams in the case of reducing the density of an object image and executing the blur processing; and

FIG. 30 is a perspective view showing an example of the external appearance of a game apparatus for business use to which the present invention is applied.

### DETAILED DESCRIPTION OF THE PREFERRED EMBODIMENTS

Hereinafter, the preferred embodiments of the present invention are described with reference to the attached drawings. Incidentally, although a case where the present invention is applied to a motorbike race game is described below, the embodiments to which the present invention can be applied are not limited to the motorbike race game.

[External Appearance]

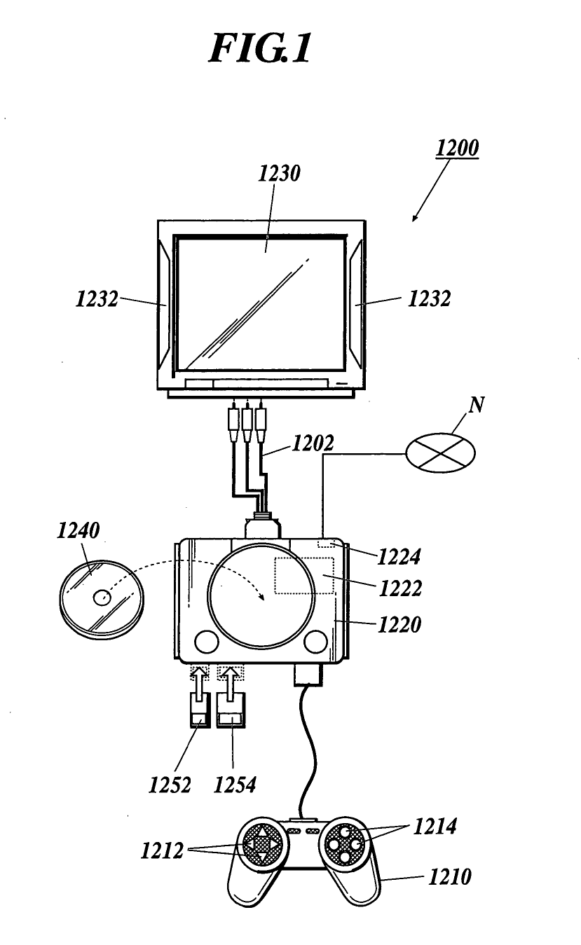

FIG. 1 is a schematic external appearance view of a household game apparatus to which the present invention is applied. As shown in the view, the household game apparatus 1200 is equipped with a main body apparatus 1220, a game controller 1210 including direction keys 1212 and button switches 1214 for a player to input game operations, and a display 1230 including speakers 1232. The game controller 1210 is connected to the main body apparatus 1220, and the display 1230 is connected to the main body apparatus 1220 with cables 1202 which can transmit an image signal and a sound signal.

The game information and the like containing a program, data and the like which are necessary for the main body apparatus 1220 to perform game processing are stored in, for example, a CD-ROM 1240, a memory card 1252, an IC card 1254 and the like which are information storage media which can be freely detached and attached from and to the main body apparatus 1220. Alternatively, the game information and the like may be obtained from an external apparatus by connecting the main body apparatus 1220 with a communication line N through a communication apparatus 1224 which the main body apparatus 1220 possesses. Hereupon, the communication line N means a communications channel through which a data transfer is possible. That is, the communication line N means to include communication networks such as a telephone communication network, a cable network and the Internet besides a LAN composed of private lines (private cables) for direct connection and Ethernet (registered trademark), and the communication system of the communication line N may be either of the wired one and the wireless one.

Moreover, the main body apparatus 1220 possesses, for example, a control unit 1222 installing memories such as a ROM and a RAM, and a reading apparatus of the information storage medium such as the CD-ROM 1240 besides the CPU. The main body apparatus 1220 executes various kinds of game processing based on the game information read from the CD-ROM 1240 and the like and an operation signal from the game controller 1210, and generates an image signal of a game screen and a sound signal of a game sound. Then, the main body apparatus 1220 outputs the generated image signal and the generated sound signal to the display 1230 to make the display 1230 display a game screen, and to make the speakers 1232 output game sounds. A player looks at the game screen displayed on the display 1230 and listens to the game sounds output from the speaker 1232 while enjoying a game by operating the game controller 1210.

Two embodiments applied to such a household game apparatus 1200 are hereinafter described in order.

### FIRST EMBODIMENT

A first embodiment is described first.

<Game Screen>

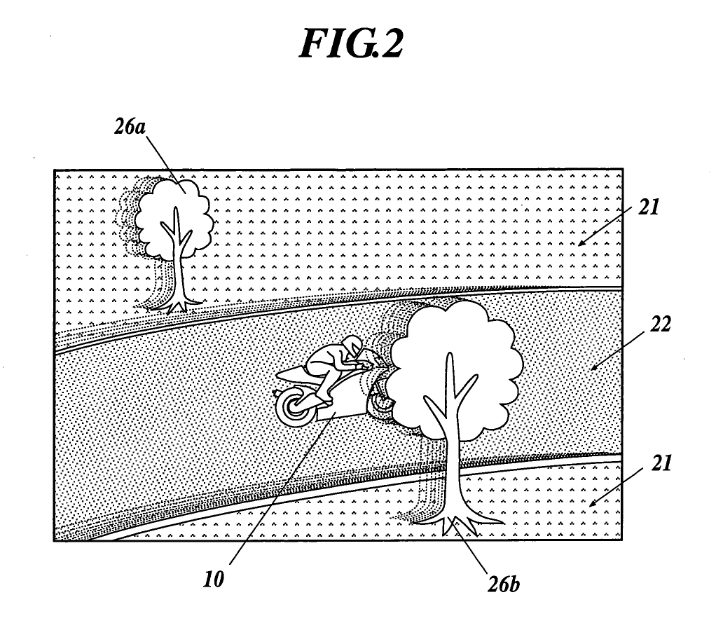

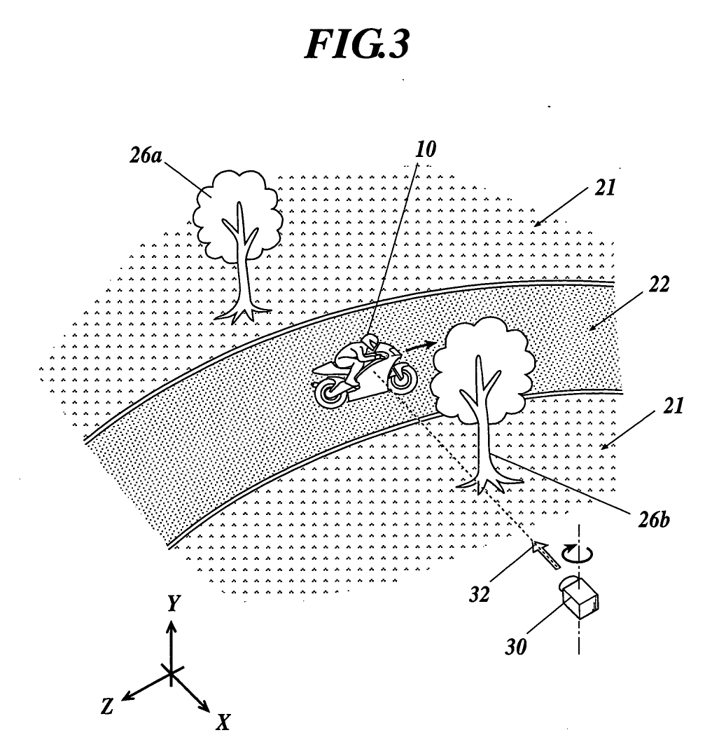

FIG. 2 is a view showing an example of a game screen in the first embodiment. In the game screen, a state of a game space (object space) set by arranging objects such as a background and characters in a virtual three-dimensional space is displayed as a three-dimensional CG image as seen from a given visual point such as a virtual camera. Then, FIG. 3 is a view showing the game space in the case where the game screen of FIG. 2 is displayed.

As shown in FIG. 3, in the game space, a ground surface which is parallel to the X-Z plane of a world coordinate system (X, Y, Z), and the top face of which is set to the side of positive direction of the Y-axis is set as a reference, and topographical objects such as a ground 21 and a race course 22 are arranged to configure a game field. Incidentally, it is supposed that the game field is formed in an almost flat surface which does not have undulations. Then, in the game field, view forming objects such as trees 26a and 26b, a building and a fence, the moving body 10 imitating a motorbike, the virtual camera 30, which is the visual point, and the like are arranged.

The moving body 10 is a player character controlled in accordance with an operation input of a player, and mainly moves on the race course 22. Moreover, the objects other than the moving body 10 such as a topographical object and a view forming object (hereinafter collectively referred to as “background objects”) are objects which do not move (their positions do not change).

In the first embodiment, the virtual camera 30 is set at a predetermined position in the game space in order that the sight line direction thereof may face the moving body 10 (minutely, a position of the representative point of the moving body 10). Concretely speaking, the position of the virtual camera 30 is kept to be fixed while the posture thereof is changed with the movement of the moving body 10. Thereby, the sight line direction of the virtual camera 30 is controlled to face the moving body 10 always.

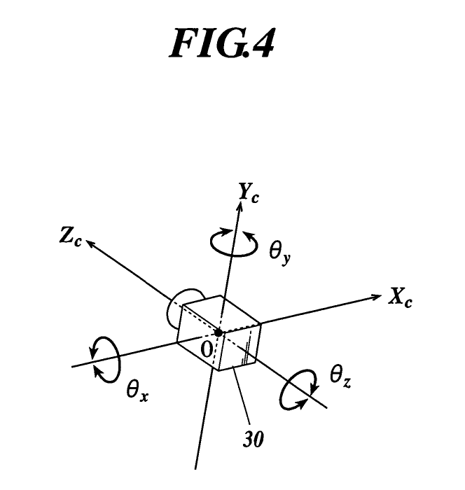

A camera coordinate system (Xc, Yc, Zc), which is a local coordinate system of the virtual camera 30, is set in order that the sight line direction thereof may agree with the positive direction of the Zc axis, and that the vertical upper direction of the virtual camera 30 may agree with the positive direction of the Yc axis, and that the right direction thereof may agree with the positive direction of the Xc axis, when the center of the virtual camera 30 is set at the origin O, as shown in FIG. 4. Then, the posture of the virtual camera 30 is controlled by rotating the virtual camera 30 around each axis of the Xc axis, the Yc axis and the Zc axis. Moreover, the posture of the virtual camera 30 is expressed by the rotation angles (θx, θy, θz) around each axis of the Xc axis, the Yc axis and the Zc axis.

As mentioned above, the moving body 10 moves on the game field, which is a nearly flat surface, and the position thereof does not change into the direction along the Y axis (namely, the Y coordinate value does not change). For this reason, by controlling the virtual camera 30 in order to rotate the virtual camera 30 around the Yc axis mainly with hardly rotating the virtual camera 30 around the Xc axis and the Zc axis, it is possible to control the virtual camera 30 in order that the sight line direction thereof may always face the moving body 10.

Therefore, in the game screen of the first embodiment, as shown in FIG. 2, the moving body 10 is displayed to be arranged at almost the center in the screen. Moreover, each object is displayed as follows: the position of the moving body 10, which the sight line direction of the virtual camera 30 faces, does not change in the screen, and the positions of the background objects such as the race course 22 and the trees 26a and 26b change in the screen.

That is, in the game screen, the outline, the color and the like of the moving body 10, the position of which does not change in the screen, are more clearly displayed in comparison with the background objects, and the background objects, the positions of which change in the screen, are displayed with blurs produced in the direction reverse to the movement direction of the moving body 10. In the view, the movement direction of the moving body 10 is the right-hand side in the view, and blurs are displayed to be produced on the background objects such as the race course 22 and the trees 26a and 26b in the left-hand side in the view.

Moreover, although a part of the moving body 10 is shielded by the tree 26b located between the virtual camera 30 and the moving body 10 in the visual field of the virtual camera 30 when the moving body 10 is seen from the virtual camera 30 in the game screen shown in FIG. 2, also the tree 26b is displayed in a state in which a blur is produced on the tree 26b. That is, the image becomes natural one while expressing the speediness feeling of the moving body 10 in the way in which no blur is produced on the moving body 10, being the moving body, and blurs are produced on the background objects other than the moving body 10 independently of the positional relation of the background objects being before or behind the moving body.

<Image Generation Principle>

The generation principle of the game images in the first embodiment is described. Hereupon, a case of generating the image of the game space in the state shown in FIG. 3 is exemplified to be described.

First, as shown in FIGS. 5A and 5B, the game space is divided into two spaces based on the moving body 10 and the virtual camera 30. FIG. 5A is a vertical sectional view of the game space along the sight line direction of the virtual camera 30, and FIG. 5B is a plan view of the game space. As shown in the views, the game space includes the position (the position of the representative point of the moving body 10) of the moving body 10, and by a vertical plane 40 perpendicular to the sight line direction of the virtual camera 30 in plane vision, the game space is divided into two spaces of one in the rear (rear space) of the moving body 10 as seen from the virtual camera 30 and one in the front (front space) of the moving body 10 as seen from the virtual camera 30.

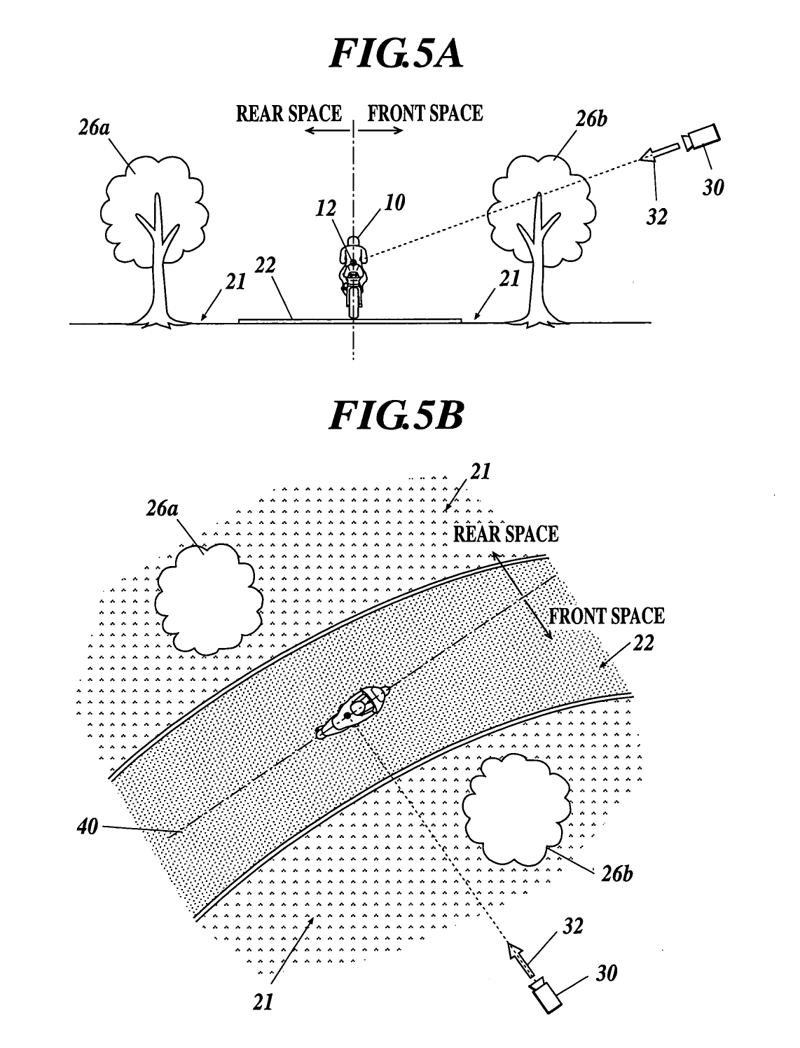

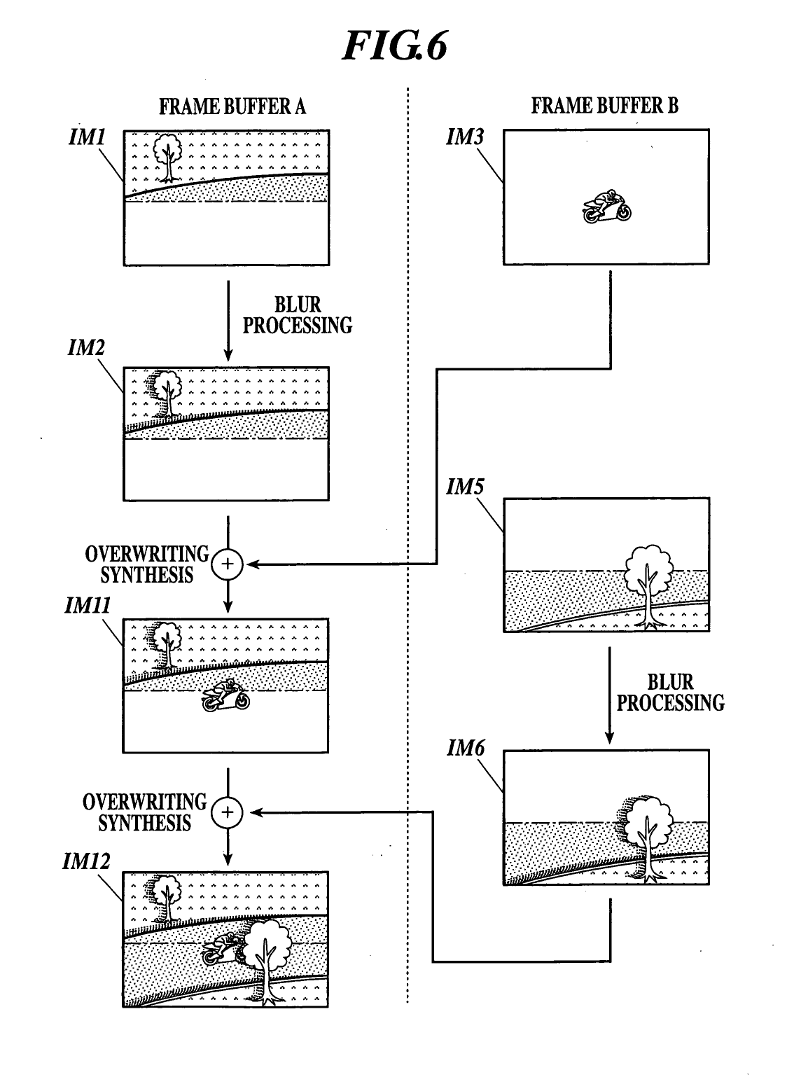

FIG. 6 is a view for illustrating the image generation procedure in the first embodiment. In the first embodiment, image generation is performed using two frame buffers (A) and (B). The frame buffer (A) is a main buffer, in which the image to be finally displayed is stored, and the frame buffer (B) is used as a working buffer. In the view, the images to be stored in the frame buffer (A) are shown on the left side, and the images to be stored in the frame buffer (B) are shown on the right side.

As shown in FIG. 6, the rendering of the rear space except for the moving body 10, being a moving body, is performed based on the virtual camera 30, and then an image of the rear space (rear background image) IM1 is drawn in the frame buffer (A). Incidentally, in the view, the alternate long and short dash line located over almost the central lateral direction in each image shows the boundary between the rear space and the front space. In the rear background image IM1, color information (RGB and a values (primary color values of red, green and blue, and the value of transparency)) is set mainly in the upper part of the boundary line, and color information is mainly set in the lower part of the boundary line in a front background image IM 5 to be mentioned later. Next, predetermined blur processing to the rear background image IM1 stored in the frame buffer (A) is performed, and a rear background blur image IM2 is generated. Incidentally, the details of the blur processing will be described later.

Moreover, the rendering of the moving body 10 is performed based on the virtual camera 30, and an image (moving body image) IM3 of a moving body is drawn in the frame buffer (B). Then, the overwriting synthesis of the moving body image IM3 stored in the frame buffer (B) to the rear background blur image IM2 stored in the frame buffer (A) is performed.

Successively, the rendering of the front space except for the moving body 10 is performed based on the virtual camera 30, and an image (front background image) IM 5 of the front space is drawn in the frame buffer (B). Although the moving body image IM3 mentioned above is stored in the frame buffer (B) at this time, the moving body image IM3 is cleared, and the frame buffer (B) is updated to store the front background image IM 5. Then, predetermined blur processing is performed to the front background image IM 5 stored in the frame buffer (B) is performed, and a front background blur image IM 6 is generated. The blur processing performed here is the same processing as the blur processing performed to the rear background image IM1 mentioned above.

After that, the overwriting synthesis of the front background blur image IM 6 stored in the frame buffer (B) and the image (the image produced by the overwriting synthesis of the moving body image IM3 and the rear background blur image IM2) IM11 stored in the frame buffer (A) is performed to generate a space image IM12. Thus, the generated space image IM12 is displayed as a game image.

<Blur Processing>

The blur processing is described. Although a well-known technique may be used as the blur processing, the blur processing is performed as follows in the present embodiment. That is, a plurality of images (reproductions of the image of the object (hereinafter referred to as “object image”) of the blur processing; the reproductions will be hereinafter referred to as “reproduction images”) produced by shifting the object image (the rear back ground image IM1 or the front background image IM5 in the first embodiment) by one to several pixels at a time into the right-hand side or the left-hand side is synthesized with the object image as semitransparent images to generate a blur image.

The direction of shifting the object image and the number of the reproduction images to be synthesized (synthesis number) N are determined based on the changes of the sight line direction of the virtual camera 30. In the first embodiment, because the virtual camera 30 is controlled to rotate around the Yc axis, a displacement of a rotation angle (yaw angle) θy around the Yc axis from the front frame is treated as a change of the sight line direction, and the shifting direction of the image and the synthesis number N to be synthesized are determined based on the change angel Δθy of the yaw angel θy.

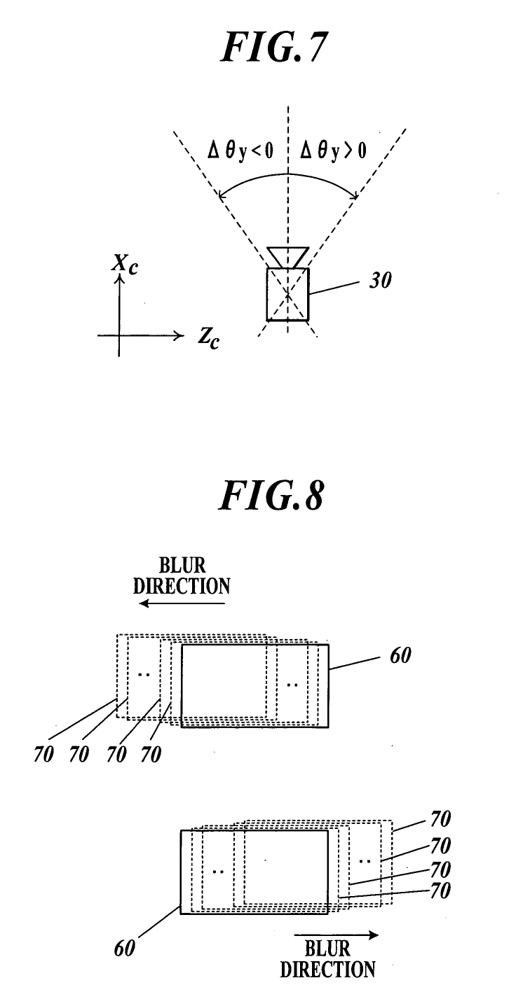

FIG. 7 is a plan view seen from the positive direction of the Yc axis of the virtual camera 30. As shown in the view, as for the positiveness and the negativeness of the change angle Δθy, it is supposed that a rotation into the clockwise direction as seen from the positive direction of the Yc axis is a “positive” rotation and a rotation into the anticlockwise direction as seen from the positive direction of the Yc axis is a “negative” rotation. That is, the change angle Δθy becomes “positive” when the sight line direction of the virtual camera 30 changes into the right-hand side on the basis of the virtual camera 30, and becomes “negative” when the sight line direction of the virtual camera 30 changes into the left-hand side. Moreover, the absolute value |Δθy| of the change angle Δθy corresponds to a variation of the sight line direction. Because the sight line direction of the virtual camera 30 is controlled to face the moving body 10 always, the sight line direction changes more and the absolute value |Δθy| of the change angle becomes larger as the movement speed of the moving body is faster. However, it is supposed that the change angle Δθy takes a value within a range of −180°<Δθy≦180°.

Then, the direction of the shifting of the image is determined based on the positiveness or the negativeness of the change angel Δθy, and the synthesis number N is determined based on the absolute value |Δθy| of the change angle Δθy.

Concretely speaking, in the case where the change angle Δθy is “positive” (Δθy>0), as shown in FIG. 8A, N reproduction images 70 produced by shifting an object image 60 into the left-side hand by one pixel at a time are generated. Moreover, in the case where the change angle Δθy is “negative” (Δθy 21 0), as shown in FIG. 8B, N reproduction images 70 produced by shifting the object image 60 into the right-hand side by one pixel at a time are generated. That is, because, in the case where the sight line direction of the virtual camera 30 changes into the “right-hand” side, the image is shifted into the “left-hand” side, the blur direction becomes the “left.” Moreover, because, in the case where the sight line direction of the virtual camera 30 changes into the “left-hand” side, the image is shifted into the “right-hand” side, the blur direction becomes the “right.” That is, the blur direction becomes the direction reverse to the change direction of the sight line direction of the virtual camera 30.

Moreover, the synthesis number N is a value according to the magnitude of the absolute value |Δθy| of the change angle Δθy, and the synthesis number N is determined to be larger as the absolute value |Δθy| is larger. The synthesis number N corresponds to the degree of the produced blur. Because the absolute value |Δθy| of the change angle Δθy becomes larger as the movement speed of the moving body 10 is faster, the synthesis number N becomes more, and the degree of the produced blur becomes larger (stronger). However, in case of |Δθy|=0, it is supposed that N=0. That is, in the case where the sight line direction does not change (Δθy=0), the number of the reproduction images 70 becomes “zero”, and no blur is produced on the object image 60.

Successively, a blur image is generated by performing the semitransparent synthesis (for example, α synthesis) of the object image 60 and the N reproduction images 70. At this time, the semitransparent synthesis is performed from the reproduction image 70 which has been shifted by the largest number of pixels in order. Incidentally, although the synthesis ratio in the semitransparent synthesis is set to 50% (50% of transparency) at this time, the other ratios may be adopted.

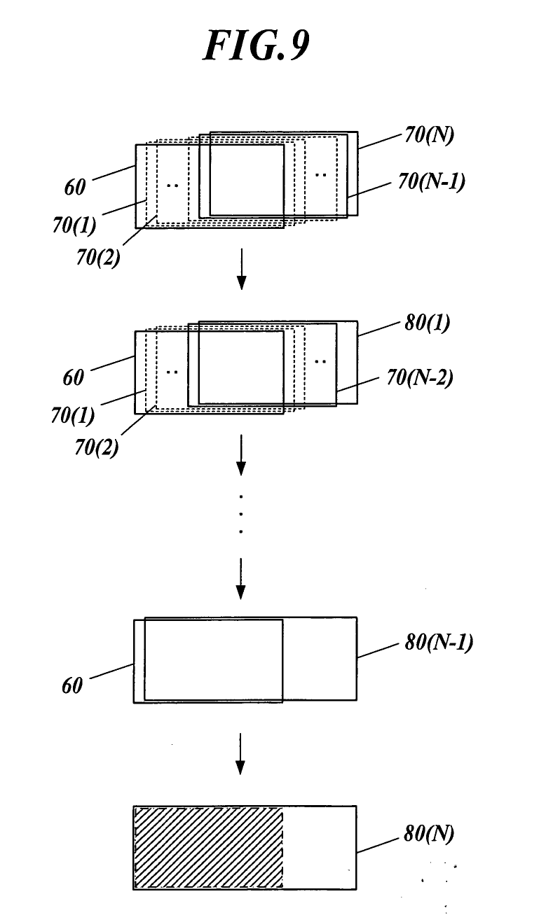

Concretely speaking, as shown in FIG. 9, among the total N reproduction images 70(1)-70(N) of from the reproduction image 70(1) produced by shifting the object image 60 by one pixel to the reproduction image 70(N) produced by shifting the object image 60 by N pixels, the semitransparent synthesis of the reproduction image 70(N), which has been shifted by the largest pixel number, and a reproduction image 70(N−1), which has been shifted by the next largest pixel number, is performed first. Next, the semitransparent synthesis of the image 80(1) after the synthesis and a reproduction image 70(N−2) is performed. Successively, the semitransparent synthesis of the image 80(2) after the synthesis and a reproduction image 70(N−3) is performed. In such a way, the semitransparent synthesis of every two of the reproduction images 70(1)-70(N) is performed in order. Lastly, an image 80(N) produced by the semitransparent synthesis of an image 80(N−1) produced by the semitransparent synthesis of N reproduction images 70(1)-70(N) and the object image 60 is generated. Then, the portion corresponds to the area from the image 80(N) to the object image 60 becomes a blur image 90 having received the blur processing of the object image 60. That is, the generated blur image 90 becomes an image in which the color information of the object image 60 is reflected to most strongly and the blurs becomes thinner as positions become more distant from the object image 60 to the shifting direction (the blur direction).

According to such blur processing, a blur image is generated by performing the semitransparent synthesis of the object image 60 and the N reproduction images according to the magnitude of the absolute value |Δθy| of the change angle Δθy which reproduction images have been produced by shifting the object images 60 by one pixel at a time in the direction according to the positiveness or the negativeness of the change angle Δθy of the yaw angle θy of the virtual camera 30. That is, the blur image to be generated becomes an image on which a blur is produced according to the variation of the sight line direction into the direction reverse to the change direction of the sight line direction of the virtual camera 30.

<Functional Configuration>

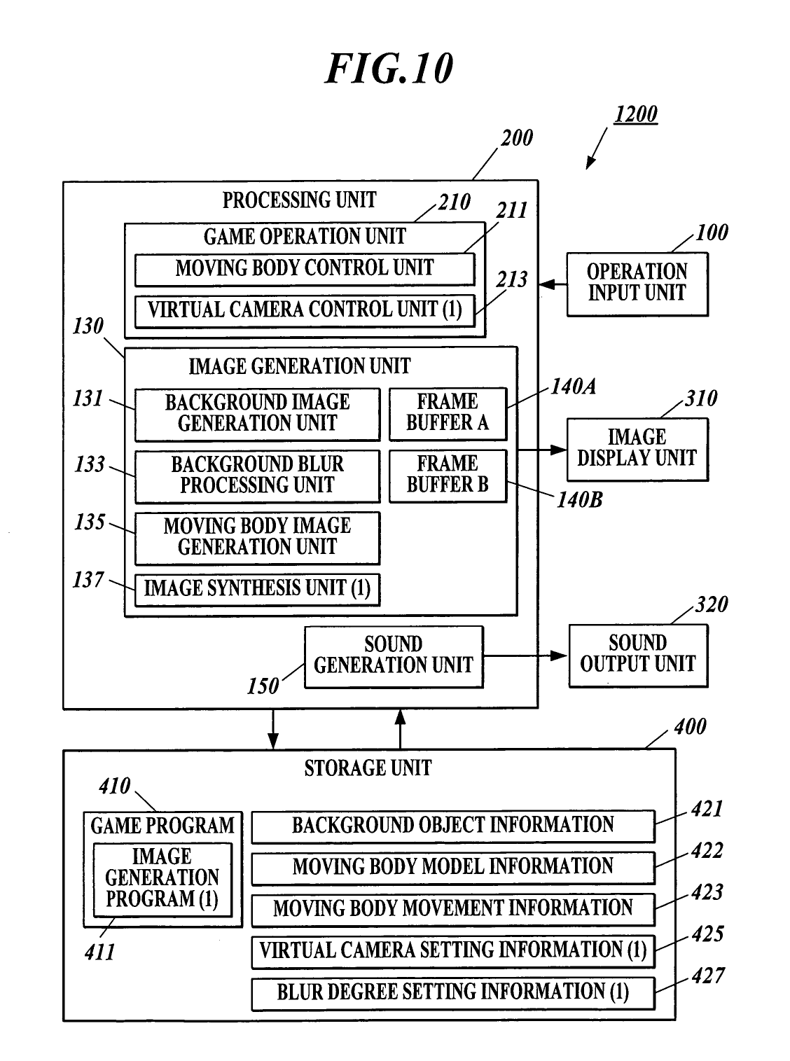

FIG. 10 is a block diagram showing the functional configuration of the household game apparatus 1200 in the first embodiment. As shown in the diagram, the household game apparatus 1200 is composed of an operation input unit 100, a processing unit 200, an image display unit 310, a sound output unit 320 and a storage unit 400.

The operation input unit 100 receives an operation instruction by a player, and outputs an operation signal according to the operation to the processing unit 200. The function is realized by, for example, button switches, a lever, dials, a mouse, a keyboard, various sensors and the like. In FIG. 1, the game controller 1210 corresponds to the operation input unit 100.

The processing unit 200 performs various kinds of operation processing such as the control of the whole of the household game apparatus 1200, the progress of a game, and image generation. This function is realized by operation apparatus such as a CPU-(CISC type one, RISC type one) and an ASIC (gate array or the like), and the control program of the operation apparatus. In FIG. 1, the CPU or the like installed in the control unit 1222 corresponds to the processing unit 200.

Moreover, the processing unit 200 includes an game operation unit 210 performing operation processing relative to the execution of a game mainly, an image generation unit 130 generating an image of a virtual three-dimensional space (game space) as seen from a given visual point of a virtual camera and the like based on various kinds of data obtained by the processing of the game operation unit 210, and a sound generation unit 150 generating game sounds such as a sound effect and a BGM.

The game operation unit 210 executes various game processing based on an operation signal input from the operation input unit 100, game information (a program and data) read from the storage unit 400, and the like. As the game processing, for example, there are arrangement processing of various objects such as background objects (such as the ground 21, the race course 22 and the trees 26a and 26b) and the moving body 10 into the game space, control processing of the virtual camera 30, being a visual point, control processing of the moving body 10, being a player character, based on an operation signal from the operation input unit 100, hit judgment processing of various objects, and the like. Moreover, in the first embodiment, the game operation unit 210 includes a moving body control unit 211 and the virtual camera control unit 213.

The moving body control unit 211 controls the movement of the moving body 10. Concretely speaking, the moving body control unit 211 operates the position of the moving body 10 in the next frame based on the present movement speed and the present movement direction, the operation signal input from the operation input unit 100, and the like every frame to arrange the moving body 10 at the operated position.

The model data of the moving body 10 is stored in moving body model information 422.

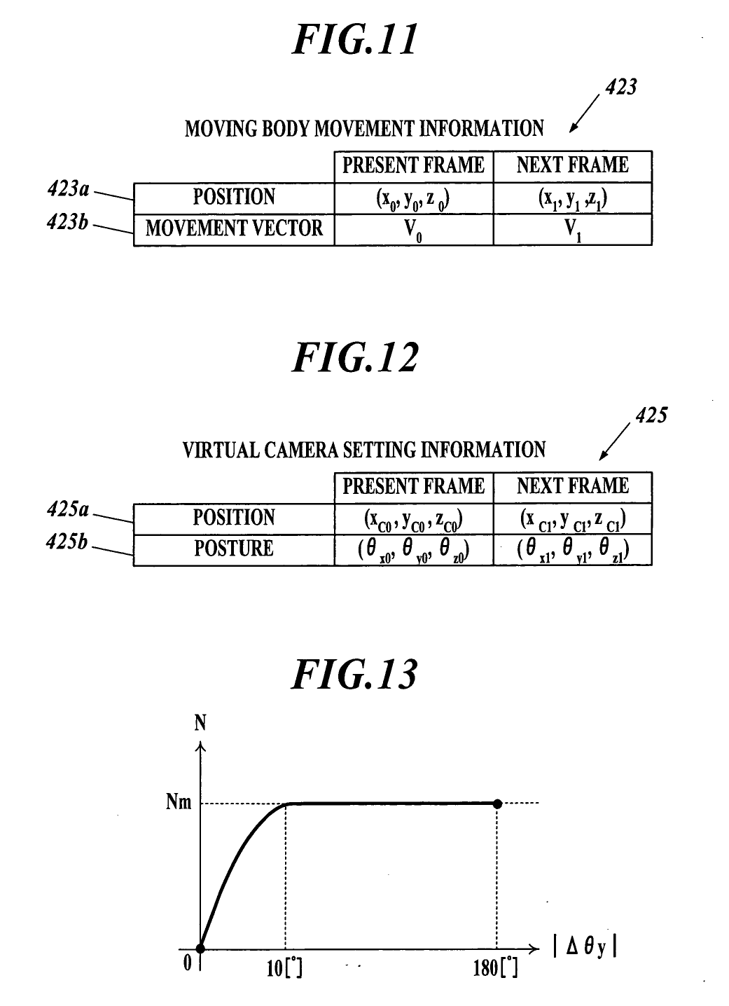

Moreover, the data relative to the movement of the moving body 10 is stored in moving body movement information 423. An example of the data configuration of the moving body movement information 423 is shown in FIG. 11. According to the view, positions 423a and movement vectors 423b of the moving body 10 in the present frame and the next frame are stored in the moving body movement information 423. The movement vectors 423b are vectors expressing movement speeds and movement directions. The positions 423a and the movement vectors 423b are expressed by the world coordinate system (X, Y, Z), and are updated by the moving body control unit 211 every frame.

The virtual camera control unit 213 sets the virtual camera 30, being the visual point, in the game space. Concretely speaking, the virtual camera control unit 213 sets the virtual camera 30 at a predetermined position in the game space in order that the sight line direction thereof may face the moving body 10. That is, the virtual camera control unit 213 controls the virtual camera 30 by changing the posture thereof in order that the sight line direction may face the position of the moving body 10 in the next frame operated by the moving body control unit 211 every frame.

The set values of the virtual camera 30 are stored in virtual camera setting information 425. An example of the data configuration of the virtual camera setting information 425 is shown in FIG. 12. According to the view, positions 425a and postures 425b of the virtual camera 30 in the present frame and the next frame are stored in the virtual camera setting information 425. The positions 425a are expressed by the position coordinates (x, y, z) in the world coordinate system (X, Y, Z). Moreover, the postures 425b are expressed by the rotation angles (θx, θy, θz) around each of the axes of the camera coordinate system (Xc, Yc, Zc). In the first embodiment, the positions 425a are fixed, and the postures 425b are updated by the virtual camera control unit 213 every frame.

The image generation unit 130 generates a game image (3D CG image) for displaying a game screen based on an operation result by the game operation unit 210, and outputs the image signal of the generated image to the image display unit 310. In the first embodiment, the image generation unit 130 includes the background image generation unit 131, the background blur processing unit 133, the moving body image generation unit 135 and the image synthesis unit 137, and further has two frame buffers 140A and 140B. The image generation unit 130 executes the processing in accordance with an image generation program 411 of the storage unit 400, and thereby, as shown in FIG. 2, an image in which no blur is produced on the moving body 10 and blurs are produced only on the background objects except for the moving body 10 is generated.

The background image generation unit 131 generates the images (background images) in the game space except for the moving body 10. Concretely speaking, based on the virtual camera 30 and the moving body 10, the background image generation unit 131 divides the game space into two spaces of the rear space and the front space of the moving body 10 as seen from the virtual camera 30. Then, the background image generation unit 131 performs the rendering of each of the rear space and the front space based on the virtual camera 30, and generates a rear background image and a front background image. The generated rear background image is stored in a frame buffer 140A, and the generated front background image is stored in a frame buffer 140B.

The background blur processing unit 133 performs predetermined blur processing to the background image generated by the background image generation unit 131 to generate a background blur image. Concretely speaking, the background blur processing unit 133 performs blur processing to the rear background image stored in frame buffer 140A, which rear background image has been generated by the background image generation unit 131, to generate a rear background blur image. Moreover, the background blur processing unit 133 performs blur processing to the front background image stored in the frame buffer 140B to generate a front blur image.

Concretely speaking, the background blur processing unit 133 refers to the virtual camera setting information 425 to calculate the yaw angle θy and the change angel Δθy of the virtual camera 30 between the present frame and the next frame in conformity with the following expression.
Δθy=θy₁−θy₀ (1)

In the above expression, “θy₁” indicates the yaw angle θy of the virtual camera 30 in the next frame, and “θy₀” indicates the yaw angle θy of the virtual camera 30 in the present frame.

Next, the background blur processing unit 133 refers to blur degree setting information 427 to determine the number N of the reproduction images to be synthesized (synthesis number) based on the magnitude of the absolute value |θy| of the calculated change angle θy. Then, the semitransparent synthesis of N reproduction images produced by shifting the image of the object of the blur processing (the rear background image IM1 or the front background image IM5) by one pixel at a time into the direction according to the positiveness or the negativeness of the calculated change angle Δθy in the descending order from the reproduction image which has been shifted by the largest pixel number, and then the semitransparent synthesis of the image after the synthesis and the object image is performed. Thereby, a blur image in which the blur processing has been performed to the object image is generated.

The blur degree setting information 427 is the information for determining the number N of reproduction images to be synthesized (synthesis number) at the blur processing, and, for example, the blur degree setting information 427 is stored as a function expression of a graph shown in FIG. 13. In the view, the graph in which the abscissa axis indicates the absolute value |Δθy| of the change angle Δθy and the ordinate axis indicates the synthesis number N is shown. According to the graph shown in the view, the synthesis number N is “0” in case of |Δθy|=0, and increases with the increase of the absolute value |Δθy|. Then, the synthesis number N becomes the upper limit value “Nm” at the absolute value |Δθy|=10°, and is always the upper limit value “Nm” after that independently of the increase of the absolute value |Δθy|. Incidentally, the graph shown in FIG. 13 is only an example, and the synthesis number N may be expressed by, for example, a linear function, a quadratic function or the like. Moreover, the upper limit value may not be set.

The moving body image generation unit 135 performs the rendering of the moving body 10 based on the virtual camera 30 to generate a moving body image. The generated moving body image is stored in the frame buffer 140B.

The image synthesis unit 137 synthesizes the rear background blur image, the front background blur image, both having been generated by the background blur processing unit 133, and the moving body image generated by the moving body image generation unit 135 to generate a space image. Concretely speaking, the overwriting synthesis of the rear background blur image stored in the frame buffer 140A and the moving body image stored in the frame buffer 140B is performed. Subsequently, the overwriting synthesis of the image after synthesis, which is stored in the frame buffer 140A, and the front background blur image stored in the frame buffer 140B is performed to generate a space image, and the space image is displayed on the image display unit 310 as the game image.

The image display unit 310 displays a game screen based on the image signal from the image generation unit 130, re-drawing the screen of one frame every 1/60 seconds, for example. The function is realized by hardware such as a CRT, an LCD, an ELD, a PDP and an HMD. In FIG. 1, the display 1230 corresponds to the image display unit 310.

The sound generation unit 150 generates game sounds such as sound effects and a BGM which are used during a game, and outputs the sound signals of the generated game sounds to the sound output unit 320.

The sound output unit 320 outputs game sounds such as a BGM and a sound effect based on the sound signal from the sound generation unit 150. The function is realized by, for example, a speaker or the like. In FIG. 1, the speakers 1232 correspond to the sound output unit 320.

The storage unit 400 stores a system program for realizing various functions for making the processing unit 200 synthetically control the household game apparatus 1200, programs necessary for executing games, data and the like. The storage unit 400 is used as a working area of the processing unit 200, and temporarily stores operation results of the execution of the processing unit 200 in accordance with various programs, input data input from the operation input unit 100, and the like. The function is realized by, for example, various IC memories, a hard disk, a CD-ROM, a DVD, an MO, a RAM, a VRAM and the like. In FIG. 1, the ROM, the RAM and the like mounted in the control unit 1222 correspond to the storage unit 400.

Moreover, the storage unit 400 stores the game program 410 for making the processing unit 200 function as the game operation unit 210, and game data. In the first embodiment, the image generation program 411 for making the processing unit 200 function as the image generation unit 130 is included in the game program 410. The storage unit 400 stores the background object information 421, the moving body model information 422, the moving body movement information 423, the virtual camera setting information 425, and the blur degree setting information 427, as the game data.

The background object information 421 is data of the background objects such as the ground 21, the race course 22 and the trees 26a and 26b for setting the game space, and includes the positions and the postures of the background objects, model data, texture data, and the like.

<Flow of Processing>

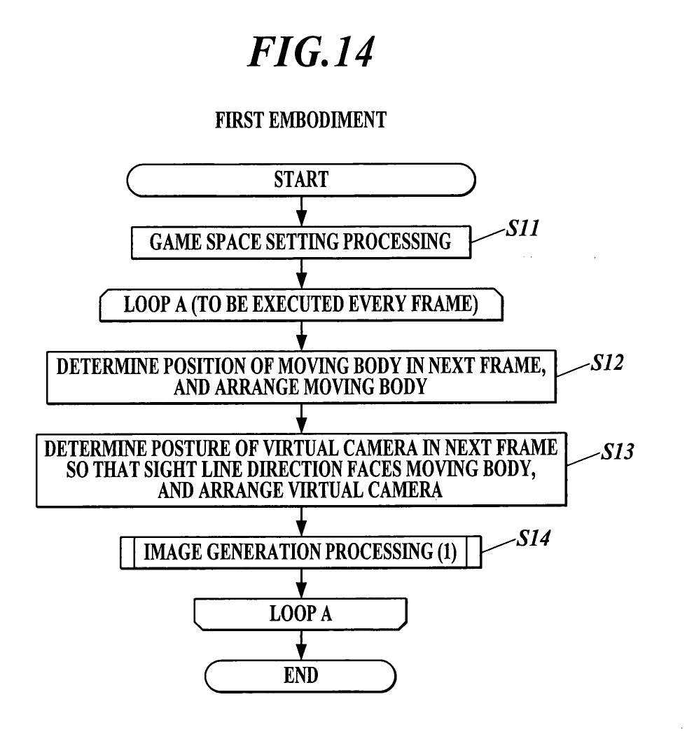

FIG. 14 is a flowchart for illustrating the flow of the processing in the first embodiment. Incidentally, because the processing relative to the progress of a game can be executed similarly to the convention processing, hereupon the processing relative to image generation is mainly described.

According to FIG. 14, first, based on the background object information 421, the game operation unit 210 arranges the background objects in the virtual three-dimensional space to set a game space. Then, the moving body control unit 211 arranges the moving body 10 at a predetermined initial position in the game space, and the virtual camera control unit 213 arranges the virtual camera 30 at a predetermined initial position in a predetermined initial posture (Step S11). After that, the processing of a loop A is executed every frame.

In the loop A, the moving body control unit 211 refers to the moving body movement information 423 to operate the position of the moving body 10 in the next frame based on the position and the movement vector of the moving body 10 in the present frame, an operation input signal from the operation input unit 100, and the like, and then the moving body control unit 211 arranges the moving body 10 at the operated position (Step S12). Subsequently, the virtual camera control unit 213 operates the posture of the virtual camera 30 in order that the sight line direction of the virtual camera 30 may face the operated position of the moving body 10 in the next frame, and controls the virtual camera 30 into the operated posture (Step S13). After that, the image generation unit 130 executes image generation processing (Step S14).

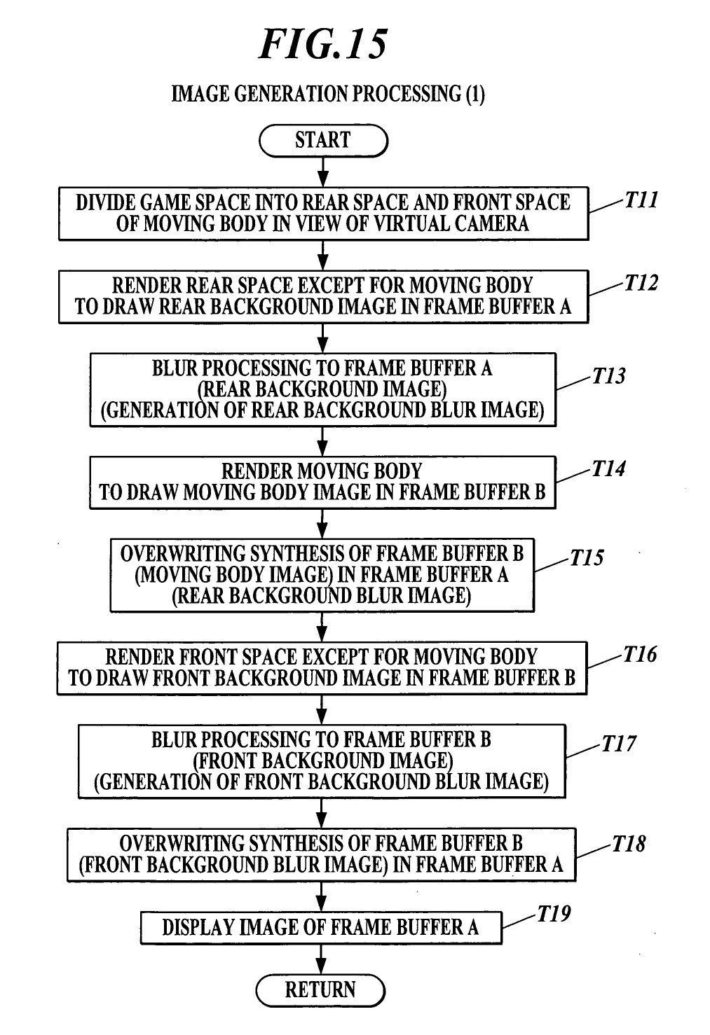

FIG. 15 is a flowchart for illustrating the flow of the image generation processing. The processing is realized by the execution of the image generation program 411 by the image generation unit 130. As shown in the chart, in the image generation processing, the background image generation unit 131 divides the game space into the rear space and the front space of the moving body 10 as seen from the virtual camera 30 on the basis of a moving body object and the moving body 10 (Step T11).

Subsequently, the background image generation unit 131 carries out the rendering of the rear space except for the moving body 10 based on the virtual camera 30, and draws the rear background image into the frame buffer 140A (Step T12). Then, the background blur processing unit 133 refers to the virtual camera setting information 425 and the blur degree setting information 427 to perform the blur processing to the rear background image stored in the frame buffer 140A based on the change of the sight line direction of the virtual camera 30 between the present frame to the next frame, and generates a rear background blur image (Step T13).

Moreover, the moving body image generation unit 135 renders the moving body 10 based on the virtual camera 30, and draws the moving body image thereof in the frame buffer 140B (Step T14). Then, the image synthesis unit 137 carries out the overwriting synthesis of the moving body image stored in the frame buffer 140B and the rear background blur image stored in the frame buffer 140A (Step T15).

Successively, based on the virtual camera 30, the background image generation unit 131 carries out the rendering of the front space except for the moving body 10, and draws the front background image in the frame buffer 140B. At this time, the image (moving body image) stored in the frame buffer 140B is cleared, and the contents of the frame buffer 140B are updated to the front background image (Step T16).

Subsequently, to the rear background image stored in the frame buffer 140B, similarly to the front background image (Step T13), the background blur processing unit 133 performs the blur processing based on the change of the sight line direction of the virtual camera 30 between the present frame to the next frame, and generates a front background blur image (Step T17).

After that, the image synthesis unit 137 carries out the overwriting synthesis of the front background blur image stored in the frame buffer 140B and the image (the image having received the overwriting synthesis of the rear background blur image and the moving body) stored in the frame buffer 140A to generate a space image (Step T18), and makes the image display unit 310 display the generated space image as a game image (Step T19).

After performing the above processing, the image generation unit 130 ends the image generation processing, and ends the process at Step S14 of FIG. 14.

When the image generation processing has ended, the processing of the loop A for one frame ends. After that, until the end of the game at the time, for example, when the moving body 10 arrives at a predetermined goal point, or when a predetermined limit time has elapsed, the processing of the loop A is repeatedly executed every frame. At the time of game end, the present processing ends.

<Hardware Configuration>

FIG. 16 is a view showing an example of the hardware configuration of the household game apparatus 1200 in the present embodiment. According to the view, the household game apparatus 1200 includes a CPU 1000, a ROM 1002, a RAM 1004, an information storage medium 1006, an image generation IC 1010, a sound generation IC 1008 and I/O ports 1012 and 1014, and these components are mutual connected in the state capable of performing the input and the output of data mutually through a system bus 1030. Moreover, a display apparatus 1018 is connected to the image generation IC 1010; a speaker 1020 is connected to the sound generation IC 1008; a control apparatus 1022 is connected to the I/O port 1012; and a communication apparatus 1024 is connected to the I/O port 1014.

The CPU 1000 performs the control of the whole of the household game apparatus 1200 and various kinds of data processing in accordance with the programs and data stored in the information storage medium 1006, the system program and the data stored in the ROM 1002, operation input signals input with the control apparatus 1022, and the like. The CPU 1000 corresponds to the processing unit 200 in FIG. 10.

The ROM 1002, the RAM 1004 and the information storage medium 1006 correspond to the storage unit 400 in FIG. 10. The ROM 1002 especially stores a program, data and the like which have been set beforehand among the system program of the household game apparatus 1200 and the information stored in the storage unit 400 in FIG. 10. The RAM 1004 is a storage unit used as a working area of the CPU 1000, and stores, for example, the given contents of the ROM 1002 and the information storage medium 1006, the image data for one frame, the operation result of the CPU 1000, and the like. Moreover, the information storage medium 1006 is realized by an IC memory card, a hard disk unit, an MO or the like which can be freely detached and attached to a main body apparatus.

The image generation IC 1010 is an integrated circuit which generates the pixel information of the game screen displayed on the display apparatus 1018 based on the image information from the CPU 1000. The display apparatus 1018 displays the game screen based on the pixel information generated by the image generation IC 1010. The image generation IC 1010 corresponds to the image generation unit 130 in FIG. 10, and the display apparatus 1018 corresponds to the image display unit 310 in FIG. 10 and the display 1230 in FIG. 1.

The sound generation IC 1008 is an integrated circuit which generates game sounds such as a sound effect and a BGM based on the information stored in the information storage medium 1006 and the ROM 1002, and the generated game sounds are output by the speaker 1020. The sound generation IC 1008 corresponds to the sound generation unit 150 in FIG. 10, and the speaker 1020 corresponds to the sound output unit 320 in FIG. 10, and the speaker 1232 in FIG. 1.

Incidentally, the processing performed in the image generation IC 1010, the sound generation IC 1008 and the like may be executed based on software by the CPU 1000, a general purpose DSP or the like.

The control apparatus 1022 is an apparatus for a player to input various game operations according to the progress of a game. The control apparatus 1022 corresponds to the operation input unit 100 in FIG. 10, and the game controller 1210 in FIG. 1.

The communication apparatus 1024 is an apparatus for exchanging various kinds of information to be used in the household game apparatus 1200 with the outside, and is used for transmitting and receiving given information according to a game program in the state of being connected with another household game apparatus, and for transmitting and receiving the information such as the game program through a communication line, and the like. The communication apparatus 1024 corresponds to the communication apparatus 1224 possessed by the main body apparatus 1220 in FIG. 1.

<Operations and Effects>

As mentioned above, in the first embodiment, the virtual camera 30 is controlled to be located at a predetermined position in the game space including the moving body 10 in order that the sight line direction thereof may face the moving body 10. When the image of the game space based on the virtual camera 30 is generated, first, the game space is divided into the front space and the rear space of the moving body 10 as seen from the virtual camera 30, and the image (front background image) IM5 of the front space and the image (rear background image) IM1 of the rear space are generated. Then, predetermined blur processing is performed to each of the front background image IM 5 and the rear background image IM1, and the rear background blur image IM2 and the front background blur image IM 6 are generated. After that, the overwriting synthesis of the image (moving body image) IM3 of the moving body 10 and the rear background blur image IM2 is carried out, and further the overwriting synthesis of the front background blur image IM 6 and the synthesized image is carried out. Thus, the space image IM12 is generated, and the space image IM12 is displayed on the game screen as a game image.

Consequently, in the game screen, the moving body 10 is displayed at almost the center of the screen, and no blur is produced on the moving body 10, the position of which does not change in the screen, but blurs are produced on the background and the like, the positions of which change in the screen, to be displayed. Moreover, the more natural image in which the blurs are produced into the direction reverse to the movement direction of the moving body 10 is generated by performing the semitransparent synthesis of the object image and shifted images of the image to be processed after shifting the images (the front background image IM 5 and the rear background image IM1) into the direction reverse to the sight line direction of the virtual camera 30 as the predetermined blur processing.

<Modifications>

Incidentally, the first embodiment may be modified as follows.

(A) Making the Virtual Camera 30 Follow the Moving Body 10

For example, the virtual camera 30 may be controlled to follow the moving body 10. That is, the sight line direction is set to be fixed, and the virtual camera 30 is controlled in order that the sight line direction thereof may face the moving body 10 by changing the position thereof. In this case, the blur processing to the object images (the rear background image and the front background image) is performed based on the positional change direction of the virtual camera 30. In the case where the virtual camera 30 is made to follow the moving body 10, the positional change direction of the virtual camera 30 becomes a direction along the movement direction of the moving body 10. For this reason, by shifting the object images into the direction reverse to the positional change direction of the virtual camera 30 at the time of the blur processing, the space image in which the blurs are produced on the background and the like into the direction reverse to the movement direction of the moving body 10 is generated.

(A-1) Following into the Rear of the Movement of the Moving Body 10

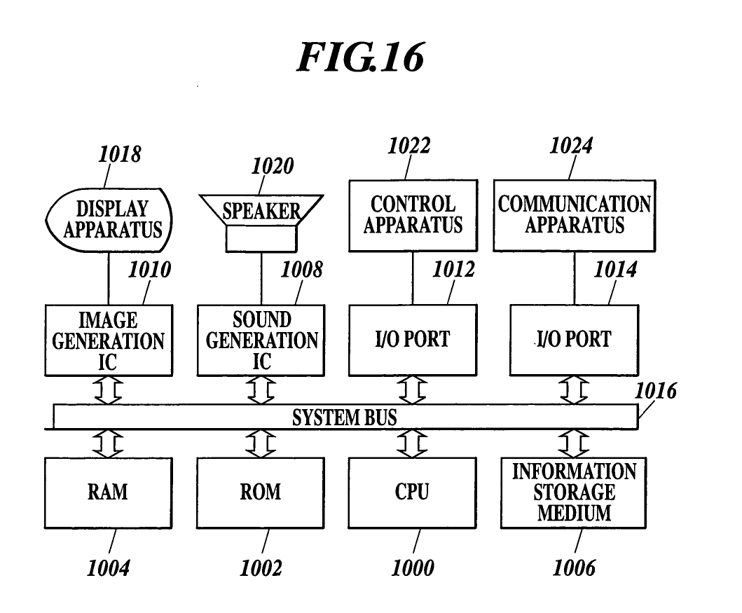

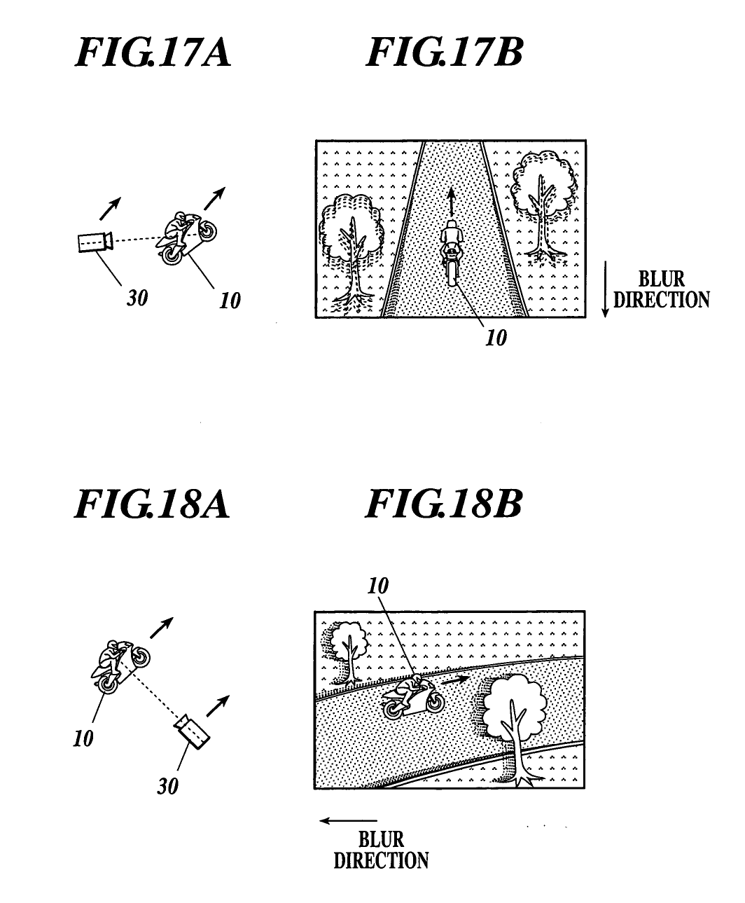

Concretely speaking, as shown in FIG. 17A, the virtual camera 30 is set to follow the rear of the movement of the moving body 10. In this case, the sight line direction of the virtual camera 30 almost agrees with the movement direction of the moving body 10 (equal to the positional change direction of the virtual camera 30). Then, as shown in FIG. 17B, there is generated an image in which the movement direction of the moving body 10 in the image becomes a “top” direction and blurs are produced on the background and the like into a “bottom” direction. That is, the space image becomes an image in which the background and the like flow into the “foreground.”

Moreover, by enlarging the size of an image to be synthesized as the pixel number shifted from the object image becomes larger at this time, a background is displayed greatly and can express more effectively the speediness feeling and the perspective of the moving body 10 as the background flows to the “foreground.”

(A-2) Running Parallel to the Moving Body 10

Moreover, as shown in FIG. 18A, the virtual camera 30 is set at a lateral direction position to the movement direction of the moving body 10 in order to run parallel to the moving body 10. In this case, the sight line direction of the virtual camera 30 crosses the movement direction of the moving body 10 (equal to the positional change direction of the virtual camera 30) at almost right angles. Then, as shown in FIG. 18B, the movement direction of the moving body 10 in the image becomes the “right-hand” side, and the image in which blurs are produced on the background and the like in the “left-hand” side is generated.

Incidentally, in the view, a case where the virtual camera 30 is set to see the moving body 10 from the “right-hand” side to the movement direction of the moving body 10 is shown. In the case where the virtual camera 30 is set to see the moving body 10 from the “left-hand” side, the movement direction of the moving body 10 becomes “left-hand” side, and an image in which blurs are produced on the background and the like into the “right-hand” side is generated.

### SECOND EMBODIMENT

Next, a second embodiment is described.

The second embodiment is an embodiment in the case where the position and the posture of the virtual camera 30 are fixed. Moreover, in the second embodiment, the same elements as those of the first embodiment mentioned above are denoted by the same reference marks as those of the first embodiment, and their detailed descriptions are omitted.

<Game Screen>

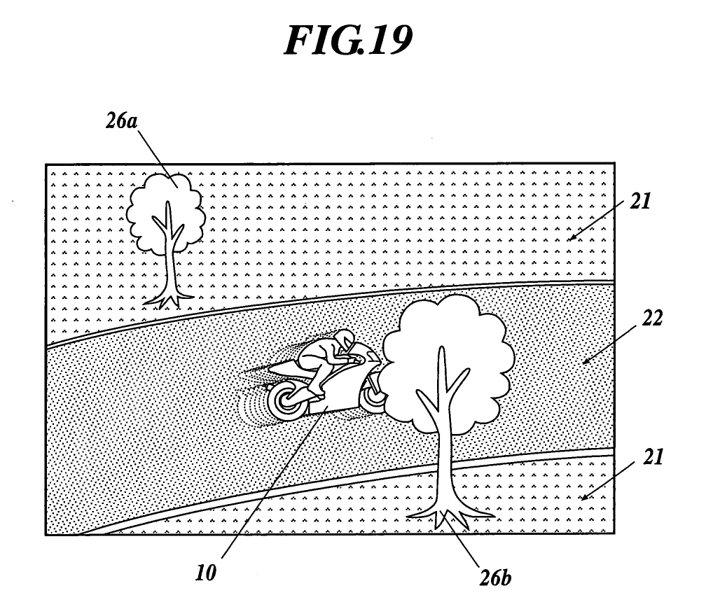

FIG. 19 is a view showing an example of a game screen in the second embodiment. In the second embodiment, the virtual camera 30 is arranged at a predetermined given position in the game space in a predetermined posture. That is, the position and the sight line direction of the virtual camera 30 become fixed. Concretely speaking, the virtual camera 30 is arranged to be fixed at a position distant from the race course 22 by a certain degree, where the virtual camera 30 looks at the race course 22 from almost lateral direction, in a posture by which the virtual camera 30 looks down at the game space from a slightly obliquely upper part.

Consequently, as shown in FIG. 19, in the second embodiment, in a game screen, the moving body 10 is displayed in order that the position thereof may change, and the background objects such as the race course 22 and the trees 26a and 26b are displayed in order that their positions do not change. The change direction of the position of the moving body 10 in the screen corresponds to the relative movement direction of the moving body 10 to the virtual camera 30 in the game space. Because the virtual camera 30 is set at the position where the virtual camera 30 looks at the race course 22, in which the moving body 10 moves, from the almost lateral direction in the posture by which the sight line direction of the virtual camera 30 faces the slightly lower part, the position of the moving body 10 changes so as to cross the game screen almost in the right and left direction (lateral direction). In the view, the moving body 10 is displayed in order that the position thereof changes toward the right-hand side in the view.

Then, in the game screen, only the moving body 10, the position of which changes in the screen, is displayed in a state in which a blur is produced thereon, and the outlines, the colors, and the like of the background objects, such as the race course 22 and the trees 26a and 26b, the positions of which do not change in the screen, are more clearly displayed in comparison with the moving body 10 in the state in which no blurs are produced thereon.

<Image Generation Principle>

The generation principle of the game images in the second embodiment is described. Hereupon, the case where the image of the game space shown in FIG. 3 in the first embodiment is generated is exemplified to be described.

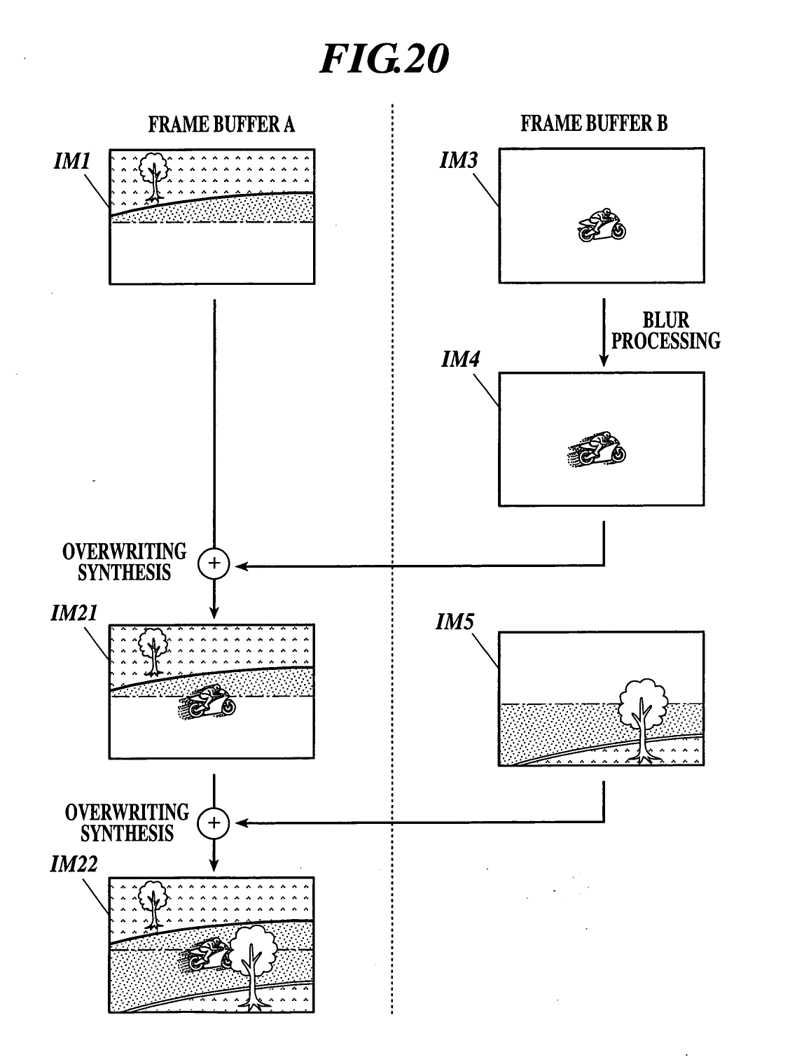

FIG. 20 is a view showing an image generation procedure in the second embodiment. In the second embodiment, two frame buffers (A) and (B) are used similarly in the first embodiment. In the view, the images stored in the frame buffer (A) are shown on the left-hand side, and the images stored in the frame buffer (B) are shown on the right-hand side. Moreover, the alternate long and short dash line in each image in the view shows the boundary of the rear space and the front space.

First, similarly to the first embodiment, a game space is divided into two spaces, the rear space and the front space, based on the moving body 10 and the virtual camera 30. Next, the rendering of the rear space except for the moving body 10 is performed based on the virtual camera 30, and the rear background image IM1 is drawn in the frame buffer (A).

Moreover, the rendering of the moving body 10 is performed based on the virtual camera 30, and the moving body image IM3 is drawn in the frame buffer (B). Successively, predetermined blur processing to the moving body image IM3 stored in the frame buffer (B) is performed, and a moving body blur image IM4 is generated. The details of the blur processing performed here will be described later. Then, the overwriting synthesis of the moving body blur image IM4 stored in the frame buffer (B) and the rear background image IM1 stored in the frame buffer (A) is carried out.

Subsequently, the rendering of the front space except for the moving body 10 is performed based on the virtual camera 30, and the front background image IM5 is drawn in the frame buffer (B). Although the moving body blur image IM4 is stored in the frame buffer (B) at this time, the moving body blur image IM4 is cleared and the frame buffer (B) is updated to the front background image IM 5. After that, the overwriting synthesis of the front background image IM5 stored in the frame buffer (B) and the image (the image produced by the overwriting synthesis of the moving body blur image IM4 and the rear background image IM1) IM21 stored in the frame buffer (A) is carried out to generate a space image IM22, and the generated space image IM22 is displayed as a game image.

<Blur Processing>

The blur processing in the second embodiment is described. Unlike the first embodiment based on the changes of the sight line direction of the virtual camera 30, in the second embodiment, the blur processing is performed based on the change directions of the relative position of the virtual camera 30 and the moving body 10. Concretely speaking, although the blur processing in the second embodiment is the same as that in the first embodiment in that a blur image is generated by carrying out the semitransparent synthesis of an object image (the moving body image IM3 in the second embodiment) and the N reproduction images produced by shifting the object image into the right or the left direction by one pixel at a time, the blur processing in the second embodiment differs from that in the first embodiment in that the image shifting direction and the number N of the reproduction images to be synthesized (synthesis number) are determined based on the change direction of the relative positions of the virtual camera 30 and the moving body 10.

In the second embodiment, because the position and the sight line direction of the virtual camera 30 are set fixedly, the changes of the position of the moving body 10 in the image based on the virtual camera 30 corresponds to the changes of the relative positions between the virtual camera 30 and the moving body 10 in the game space. Because the virtual camera 30 is set as the position where the virtual camera 30 looks at the moving body 10 from a nearly lateral direction in the posture in which the sight line direction of the virtual camera 30 becomes slightly downward, in the image based on the virtual camera 30, the position of the moving body 10 is displayed to change almost in the right and the left direction (lateral direction). Consequently, as for the positional changes of the moving body 10 in the image, the positional changes in the up and the down directions (vertical direction) are smaller than those in the right and the left directions (lateral direction). Accordingly, a change distance Δu of the moving body 10 in the right and the left directions (lateral direction) in the image is treated as a relative positional change of the moving body 10 to the virtual camera 30, and the direction of shifting the image and the synthesis number N are determined based on the change distance Δu.

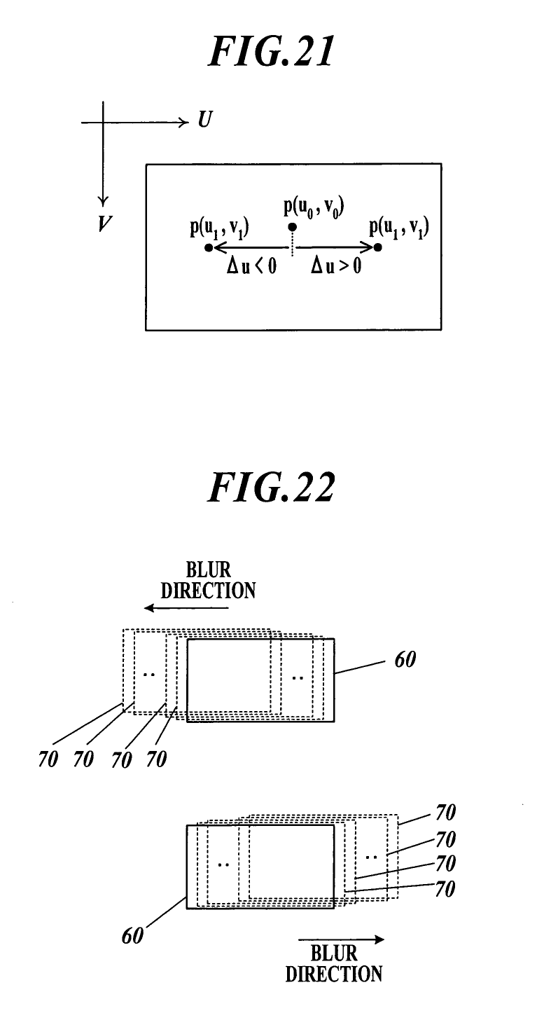

FIG. 21 is a view for illustrating the changes of the position of the moving body 10 in the image based on the virtual camera 30. As shown in the view, in the case where the position of the moving body 10 in the image changes to p1 (u₁, v₁) from p0 (u₀, v₀), the change distance Δu of the position of the moving body 10 is given by the following expression (2). Incidentally, a position in the image is expressed by the position coordinates (u, v) in the coordinate system (U, V) set to the image. Moreover, the position p of the moving body 10 in the image is obtained from the position of the moving body 10 in the game space, the position, the posture and the angle of view, which are set values of the virtual camera 30. That is, the position p in the image can be obtained by carrying out the perspective projection transformation processing of the position coordinates on the world coordinate system, which is the coordinate system of the game space, according to the set values of the virtual camera 30.
Δu=u₁−u₀ (2)

However, the change distance Δu is expressed by a ratio to the length in the right and the left directions (lateral direction) of the image. That is, the change distance Δu takes the values in a range of −1.0<Δu≦1.0.

As for the positiveness and the negativeness of the change distance Δu, as shown in the view, it is supposed that a change into the right-hand side in the image is “positive”, and a change into the left-hand side is “negative.” Moreover, the absolute value |Δu| of the change distance Δu corresponds to the variation of the relative position of the moving body 10 to the virtual camera 30. Because the position and the posture of the virtual camera 30 are set to be fixed, the absolute value |Δu| of the movement distance Δu becomes larger, as the movement speed of the moving body 10 is faster.

Then, the direction into which the image is shifted is determined based on the positiveness or the negativeness of the change distance Δu, and the synthesis number N is determined based on the absolute value |Δu| of the change distance Δu.

Concretely speaking, in the case where the movement distance Δu is “positive” (Δu>0), as shown in FIG. 22A, N reproduction images 70 produced by shifting the object image 60 into the left-hand side by one pixel at a time are generated. Moreover, in the case where the movement distance Δu is “negative” (Δu<0), as shown in FIG. 22B, N reproduction images 70 produced by shifting the object image 60 into the right-hand side by one pixel at a time are generated. That is, in the game space, in the case where the moving body 10 moves into the “right-hand” side relatively to the virtual camera 30, the image is shifted into the “left-hand” side. Consequently, the blur direction becomes the “left.” Moreover, in the case where the moving body 10 moves to the “left-hand” side relatively to the virtual camera 30, the image is shifted into the “right-hand” side. Consequently, the blur direction becomes the “right.” That is, the blur directions become the directions reverse to the relative positional changes of the moving body 10 to the virtual camera 30.

Moreover, the synthesis number N is a value according to the magnitude of the absolute value |Δu| of the movement distance Δu, and the synthesis number N is determined in order to be larger as the absolute value |Δu| is larger. Because the absolute value |Δu| of the movement distance Δu becomes larger as the movement speed of the moving body 10 is faster, i.e. as the movement speed of the moving body 10 relative to the virtual camera 30 is faster, the synthesis number N becomes larger, and the degree of a blur to be produced becomes larger (stronger). However, it is supposed that N=0 in case of |Δu|=0. That is, in the case where the moving body 10 does not move (it is stopping), the number of the reproduction images 70 becomes “0”, and no blur is produced on the object image 60.

Then, similarly in the first embodiment, a blur image is generated by performing the semitransparent synthesis (α synthesis) of the object image 60 and the N reproduction images 70.

<Functional Configuration>

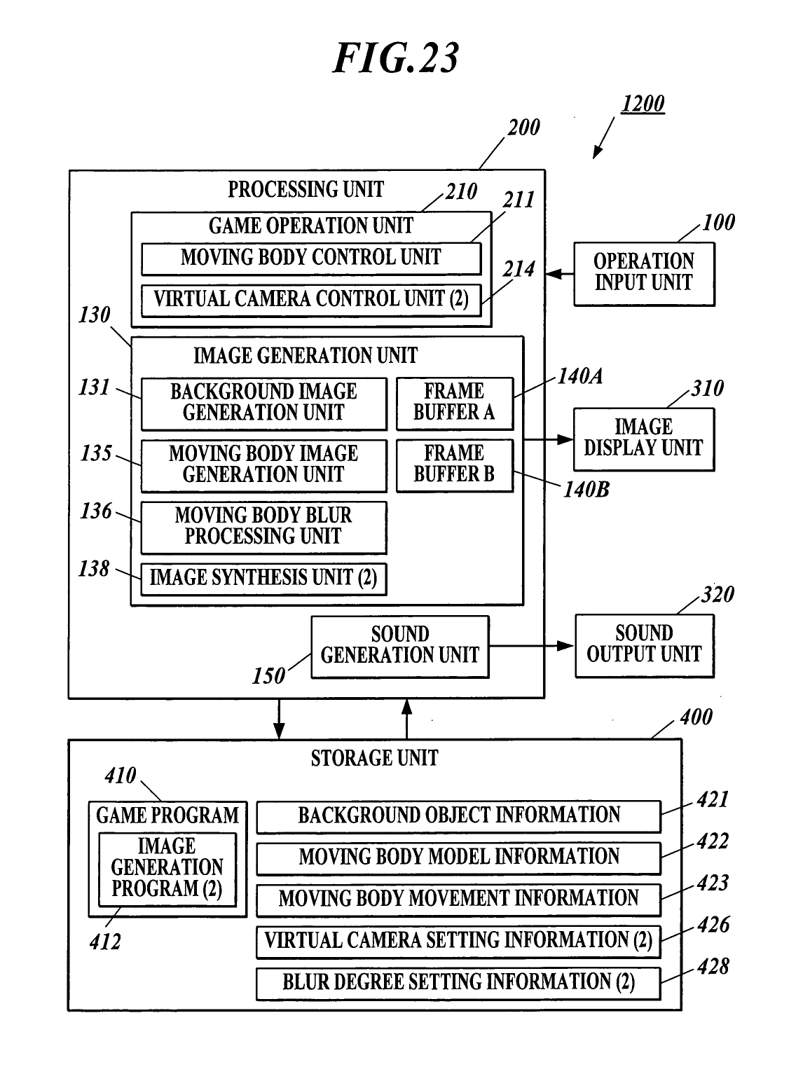

FIG. 23 is the block diagram showing the functional configuration of the household game apparatus 1200 in the second embodiment. According to the diagram, in the second embodiment, the game operation unit 210 includes the moving body control unit 211 and a virtual camera control unit 214.

The virtual camera control unit 214 sets the virtual camera 30, which is a visual point, in the game space. Concretely speaking, the virtual camera control unit 214 arranges the virtual camera 30 at a predetermined given position in the game space in a predetermined given posture according to a virtual camera setting information 426.

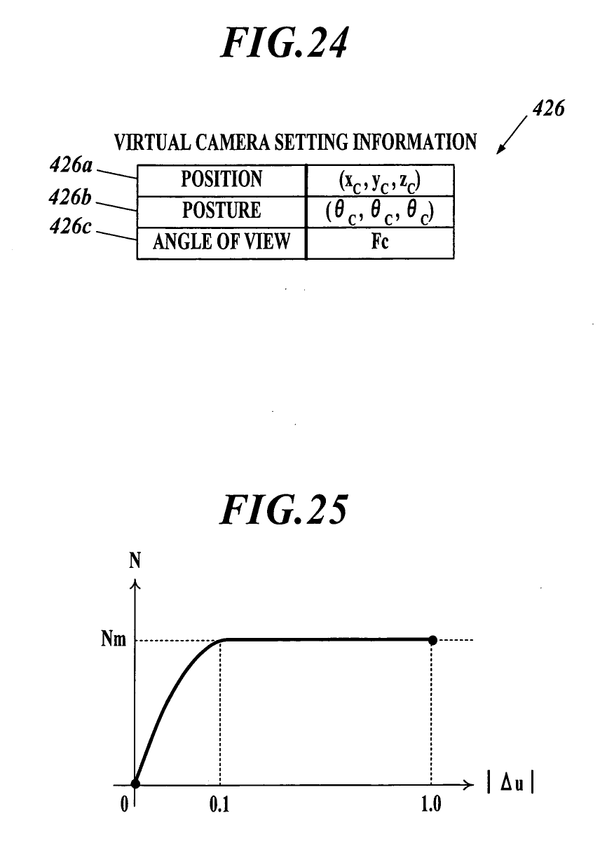

An example of the data configuration of the virtual camera setting information 426 is shown in FIG. 24. As shown in the view, the virtual camera setting information 426 stores a position 426a, a posture 426b and an angle of view 426c of the virtual camera 30. The position 426a, the posture 426b, and the angle of view 426c are fixed values set beforehand.

Moreover, the image generation unit 130 includes the background image generation unit 131, the moving body image generation unit 135, the moving body blur processing unit 136 and the image synthesis unit 138, and further includes the frame buffers 140A and 140B.

The moving body blur processing unit 136 performs the blur processing to the moving body image IM3 which has been generated by the moving body image generation unit 135 and is stored in frame buffer 140B, and generates a moving body blur image. Concretely speaking, the moving body blur processing unit 136 refers to the moving body movement information 423 and the virtual camera setting information 426 to calculate the change distance Δu of the position of the moving body 10 in the image based on the virtual camera 30 between the present frame and the next frame according to the expression (2). Subsequently, the moving body blur processing unit 136 refers to blur degree setting information 428 to determine the synthesis number N based on the magnitude of the absolute value |Δu| of the calculated change distance Δu. Then, the moving body blur processing unit 136 generates a blur image in which blur processing is performed to the object image by carrying out the semitransparent synthesis of the object image and the N reproduction images produced by shifting the object image (moving body image IM3) into a direction according to the positiveness or the negativeness of the change distance Δu by one pixel at a time.

The blur degree setting information 428 is the information for determining the synthesis number N in the second embodiment, and is stored, for example, as a function expression of the graph shown in FIG. 25. The view shows the graph in which the abscissa axis indicates the absolute values |Δu| of the change distances Δu and the ordinate axis indicates the synthesis numbers N. According to the graph shown in the view, the synthesis number N is “0” in case of |Δu|=0, and increases with the increase of the absolute value |Δu|. Then, the synthesis number N becomes the upper limit value “Nm” at |Δu|=0.1, and takes always the upper limit value “Nm” independently of the increase of the absolute value |Δu|. Incidentally, the graph shown in FIG. 25 is only an example, and the function expression may be, for example, a linear function, a quadratic function or the like, and the upper limit value may not be provided.

The image synthesis unit 138 synthesizes the rear background image and the front background image generated by the background image generation unit 131, and the moving body blur image generated by the moving body blur processing unit 136 to generate a space image. Concretely speaking, the overwriting synthesis of the moving body blur image stored in the frame buffer 140B and the rear background image stored in the frame buffer 140A is carried out. Subsequently, the overwriting synthesis of the front background image stored in the frame buffer 140B and the image after the synthesis, which is stored in the frame buffer 140A, is carried out to generate a space image, and the image synthesis unit 138 makes the image display unit 310 display the generated space image as a game image.

Moreover, in the second embodiment, an image generation program 412 for functioning the processing unit 200 as the image generation unit 130 is included in the game program 410 stored in the storage unit 400, and the storage unit 400 stores the background object information 421, the moving body model information 422, the moving body movement information 423, the virtual camera setting information 426 and the blur degree setting information 428 as game data.

<Flow of Processing>

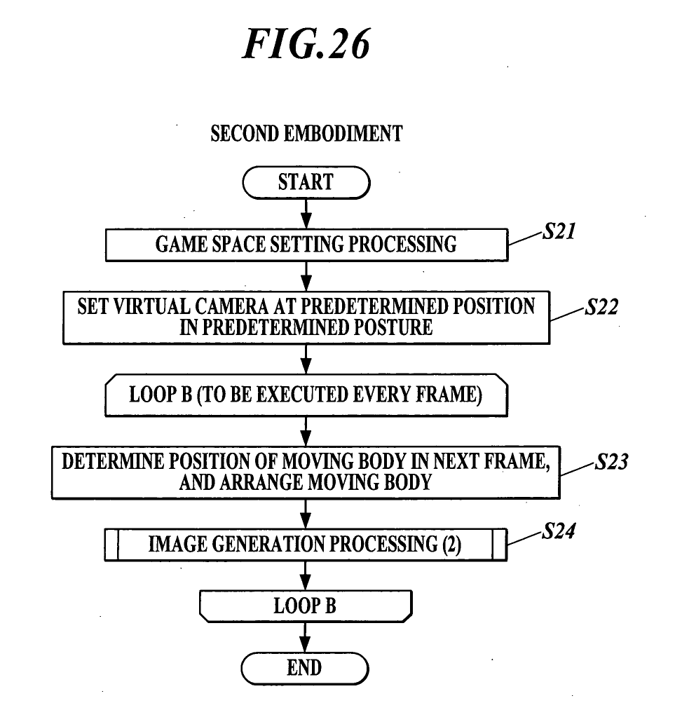

FIG. 26 is a flowchart for illustrating the flow of the processing in the second embodiment. Incidentally, because the processing relative to the progress of a game can be executed similarly to the prior art, the processing relative to the image generation is chiefly described here.

According to FIG. 26, first, the game operation unit 210 arranges background objects in a virtual three-dimensional space based on the background object information 421, and sets a game space. Then, the moving body control unit 211 arranges the moving body 10 at the predetermined initial position in the set game space (Step S21). Subsequently, the virtual camera control part 214 sets the virtual camera 30 at predetermined position in the game space in a predetermined posture based on the virtual camera setting information 426 (Step S22). After that, the processing of a loop B is performed every frame.

In the loop B, the moving body control unit 211 refers to the moving body movement information 423 to operate the position of the moving body 10 in the next frame, and arranges the moving body 10 at the operated position (Step S23). After that, the image generation unit 130 executes image generation processing (Step S24).

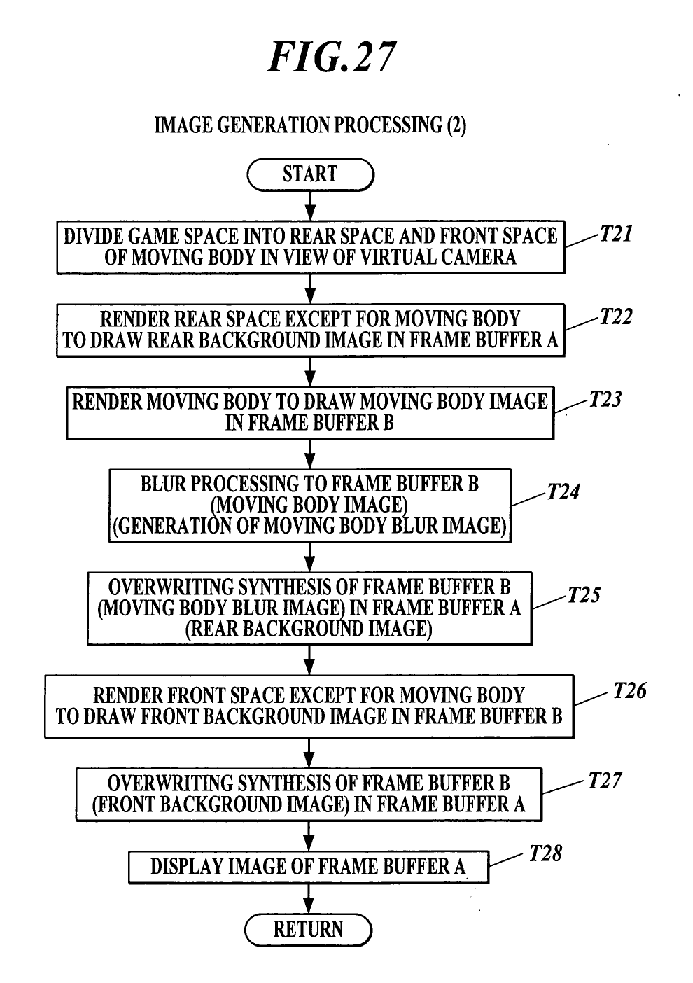

FIG. 27 is a flowchart for illustrating the flow of image generation processing. This processing is realized by the execution of the image generation program 412 by the image generation unit 130. As shown in the flowchart, in the image generation processing, the background image generation unit 131 divides the game space into the rear space and the front space of the moving body 10 as seen from the virtual camera 30 based on the moving body and the virtual camera 30 (Step T11). Subsequently, the image generation unit 130 performs the rendering of the rear space except for the moving body 10 based on the virtual camera 30, and draws a rear background image in the frame buffer 140A (Step T22).

Moreover, the moving body image generation unit 135 renders the moving body 10 based on the virtual camera 30, and draws the moving body image in the frame buffer 140B (Step T23). Subsequently, the moving body blur processing unit 136 refers to the moving body movement information 423, the virtual camera setting information 426 and the blur degree setting information 428 to perform blur processing to the moving body image stored in the frame buffer 140B based on the relative positional change direction of the moving body 10 to the virtual camera 30 between the present frame to the next frame (Step T24). Then, the image synthesis unit 138 carries out the overwriting synthesis of the moving body blur image stored in the frame buffer 140B and the rear background image stored in the frame buffer 140A (Step T25).

Successively, based on the virtual camera 30, the background image generation unit 131 carries out the rendering of the front space except for the moving body 10, and draws a front background image in the frame buffer 140A. At this time, the image (moving body blur image) stored in the frame buffer 140B is cleared, and the background image generation unit 131 updates the frame buffer 140B to the front background image (Step T26).

After that, the image synthesis unit 138 carries out the overwriting synthesis of the front background image stored in the frame buffer 140B and the image (the image produced by the synthesis of the rear background image and the moving body blur image) stored in the frame buffer 140A to generate a space image (Step T27), and the image synthesis unit 138 makes the image display unit 310 display the generated space image as a game image (Step T28).

After having performed the above processing, the image generation unit 130 ends the image generation processing, and ends the process at Step S24 of FIG. 26.

After the end of the image generation processing, the processing of the loop B for one frame ends. After that, the processing of the loop B is repeatedly executed every frame until the game ends. When the game ends, the present processing ends.

<Operations and Effects>

As mentioned above, in the second embodiment, the virtual camera 30 is set at the predetermined position in the game space including the moving body 10 with the predetermined sight line direction. That is, the position and the posture thereof are fixed. When an image in the game space is generated based on the virtual camera 30, first, the game space is divided in the front space and the rear space of the moving body 10 as seen from the virtual camera 30, and the image (front background image) IM5 of the front space and the image (rear background image) IM1 of the rear space are generated. Moreover, the image (moving body image) IM3 of the moving body 10 is generated, and predetermined blur processing is performed to the moving body image IM3 to generate the moving body blur image IM 4. Then, the overwriting synthesis of the moving body blur image IM 4 and the rear background image IM1 is carried out, and the overwriting synthesis of the front background image IM 5 is carried out further. Thus, the space image IM22 is generated, and the space image IM22 is displayed on a game screen as a game image.

Consequently, in the game screen, the position of the moving body 10 is displayed to change in an image, and a blur is produced on the moving body 10. The background and the like, the positions of which do not change in the screen, are displayed with no blur produced thereon. Moreover, the more natural image in which the blurs are produced into the direction reverse to the movement direction of the moving body 10 is generated by performing the semitransparent synthesis of the object image and shifted images of the image to be processed after shifting the image (the moving body image IM3) into the direction reverse to the positional change direction of the virtual camera 30 as the predetermined blur processing.

[Modifications]

Incidentally, the application of the present invention is not limited to the embodiment mentioned above, but the embodiment may be suitably modified without departing from the spirit and the scope of the present invention.

(A) Blur Processing

For example, although each embodiment mentioned above generates the blur image in which a blur is produced on an image to be processed (object image) by shifting the object image by one pixel at a time at the time of the blur processing, the generation of the blur image may be performed as follows.

(A-1) Enlarging an Object Image

In the blur processing in each embodiment mentioned above, an image portion on which the blur processing is not completely performed arises at the end of the generated blur image in the direction reverse to the direction in which the object image has been shifted is generated. For example, as shown in FIG. 9, in the case where an object image is shifted in the “right-hand” side, a blur is halfway produced on an image portion at the N^{th} pixel from the left side end of the generated blur image in the case where the object image is shifted to the “right-hand” side. The image portion on which the blur is halfway produced becomes no problem in the case where the synthesis number N is relatively small. But, in the case where the synthesis number N is relatively large and the ratio of the halfway blurred portion is large to the whole blur image, the image portion could be unnatural image.

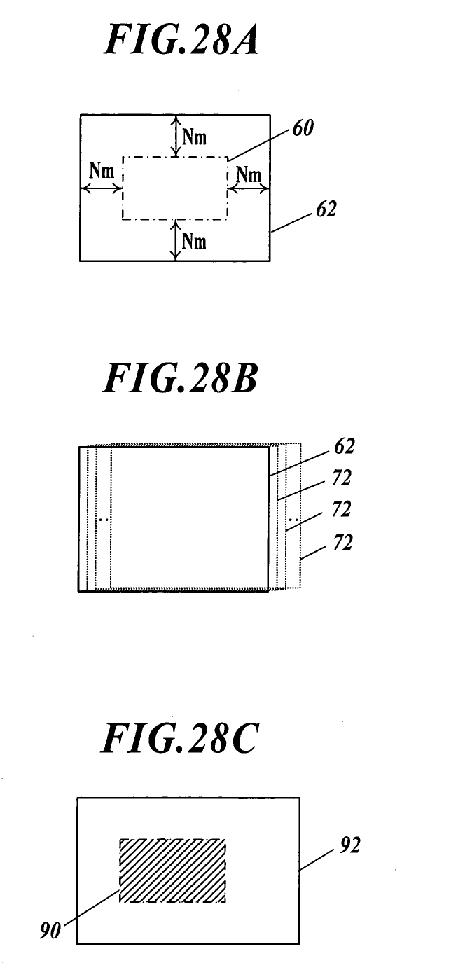

Accordingly, in order to solve such an inconvenience, as shown in FIG. 28A, the object image 60 is generated as an expanded object image 62 expanded in each direction on the left, right, top and bottom of the object image 60 by the pixel number equal to the maximum value Nm of the synthesis number N from the original size of the object image 60. Then, at the time of the blur processing, as shown in FIG. 28B, the semitransparent synthesis is performed by shifting the expanded object image 62 by one pixel at a time, and an expanded blur image 92, the expanded object image 62 on which the blur processing is performed, is thus generated. Subsequently, as shown in FIG. 28C, the central part corresponding to the size of the object image 60 is taken out from the expanded blur image 92, and the taken out part is treated as a blur image 90 of the object image 60.

(A-2) Reducing the Density of an Object Image

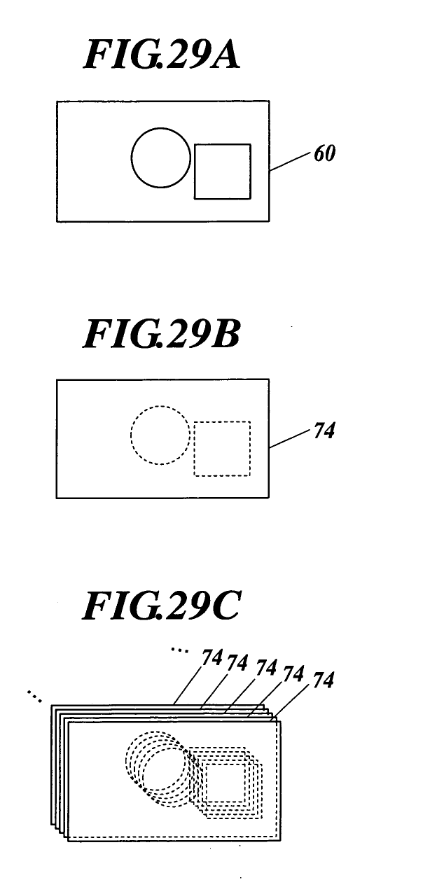

Moreover, although the semitransparent synthesis of the N reproduction images which have been produced by shifting the object image by one pixel at a time is performed in each embodiment mentioned above, a blur image may be generated by performing additive synthesis of images produced by shifting an object image the density of which has been reduced by one pixel at a time. Concretely speaking, an image 74, shown in FIG. 29B, the density of which has been reduced to “1/N” of an image (object image) 60 as an object of the blur processing as shown in FIG. 29A, is generated from the image 60. Hereupon, the “density” expresses RGB values, and “reducing the density” means reducing the RGB values. Then, as shown in FIG. 29C, a blur image is generated by performing the additive synthesis of the RGB values by shifting N images 74 by one pixel at a time.

(B) Game Apparatus to be Applied

In the embodiments mentioned above, the case where the present invention is applied to the household game apparatus has been described. However, the present invention can be applied not only to the household game apparatus 1200 shown in FIG. 1, but also the present invention can be similarly applied to various apparatus such as a game apparatus for business use, a portable game apparatus and a large-sized attraction apparatus.

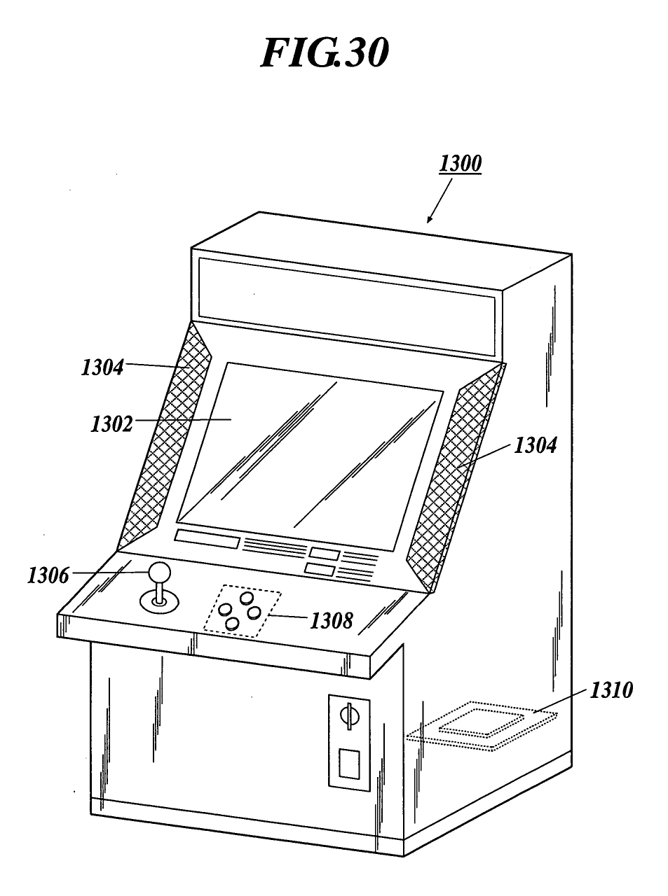

For example, FIG. 30 is an appearance view showing an example of applying the present invention to a game apparatus for business use. According to the view, an game apparatus for business use 1300 is equipped with a display 1302 displaying a game screen, a speaker 1304 outputting sound effects and a BGM of a game, a joy stick 1306 inputting the front, the back, the left and the right directions, push buttons 1308 and a control unit 1310 controlling the game apparatus for business use 1300 synthetically by operation processing to execute a given game.

The control unit 1310 installs an operation processing apparatus such as a CPU, and a ROM storing programs and data, both necessary for the control of the game apparatus for business use 1300 and the execution of a game. The CPU installed on the control unit 1310 suitably reads a program and data stored in the ROM to perform the operation processing thereof, and thereby executes various kinds of processing such as game processing. A player enjoys the game by operating the joy stick 1306 and the push buttons 1308 while looking at the game screen displayed on the display 1302 and hearing the game sounds output from the speaker 1304.

What is claimed is:

1. A program for making a computer generate a space image including a moving body moving in a virtual three-dimensional space based on a given visual point, the program making the computer function as:
a visual point control unit for controlling the visual point according to a movement of the moving body so that the moving body is arranged at a predetermined position in the space image;
a background image generation unit for generating an image in the virtual three-dimensional space except for the moving body as a background image based on the visual point;
a blur processing unit for performing predetermined blur processing to the generated background image to generate a background blur image;
a moving body image generation unit for generating an image of the moving body based on the visual point; and
a space image generation unit for synthesizing the generated image of the moving body and the background blur image generated by the blur processing unit to generate the space image.

2. The program as claimed in claim 1, wherein
the program makes the computer function in order that the direction control unit includes a sight line direction control unit for controlling a sight line direction of the visual point to face the moving body, and the blur processing unit perform the blur processing by varying a blur direction based on a change of the sight line direction controlled by the sight line direction control unit.

3. The program as claimed in claim 2, wherein
the program makes the computer function in order that the blur processing unit generates the background blur image by synthesizing a reproduction of the generated background image into a direction reverse to a change direction of the sight line direction controlled by the sight line direction control unit.

4. The program as claimed in claim 2, wherein
the program makes the computer function in order that the blur processing unit further performs the blur processing by varying a degree of a blur based on a variation of the sight line direction controlled by the sight line direction control unit.

5. The program as claimed in claim 1, wherein
the program makes the computer function in order that the visual point control unit includes a following control unit for controlling the visual point so as to follow the moving body, and the blur processing unit performs the blur processing by varying a blur direction based on a direction of a positional change of the visual point by the following control unit.

6. The program as claimed in claim 5, wherein
the program makes the computer function in order that the blur processing unit generates the background blur image by synthesizing a reproduction of the generated background image by shifting into a direction reverse to the direction of the positional change of the visual point by the following control unit.

7. The program as claimed in claim 5, wherein
the program makes the computer function in order that the following control unit controls the visual point so as to follow the moving body from a rear of a movement of the mobbing body, and the blur processing unit generates the background blur image by synthesizing reproductions of the generated background image by shifting the reproductions in order into a direction reverse to the direction of the positional change of the visual point by the following control unit, and by synthesizing the reproductions while enlarging sizes of the reproductions as the shifting is performed more times.

8. The program as claimed in claim 5, wherein the program makes the computer function in order that the blur processing unit further performs the blur processing by varying a degree of a blur based on the variation of the position of the visual point by the following control unit.

9. The program as claimed in claim 1, wherein the program makes the computer function in order that the background image generation unit includes:
a rear background image generation unit for generating an image of the virtual three-dimensional space in a rear of the moving body as seen from the visual point as a rear background image, and
a front background image generation unit for generating an image of the virtual three-dimensional space in a front of the moving body as seen from the visual point as a front background image; and that
the blur processing unit includes
a rear blur processing unit for performing the blur processing to the generated rear background image to generate a rear background blur image, and
a front blur processing unit for performing the blur processing to the generated front background image to generate a front background blur image; and further that
the space image generation unit synthesizes the generated image of the moving body and the generated rear background blur image, and further synthesizes the generated front background blur image and the synthesized image to generate the space image.

10. A program for making a computer generate a space image including a moving body moving in a virtual three-dimensional space based on a visual point a sight line direction and an arrangement position of which is previously set makes the computer function as:
a moving body image generation unit for generating an image of the moving body as a moving body image based on the visual point;
a blur processing unit for performing predetermined blur processing to the generated moving body image to generate a moving body blur image;
a rear background image generation unit for generating an image of the virtual three-dimensional space in a rear of the moving body as seen from the visual point as a rear background image;
a front background image generation unit for generating an image of the virtual three-dimensional space in a front of the moving body as seen from the visual point as a front background image; and
a space image generation unit for synthesizing the generated moving body blur image and the generated rear background image, and further synthesizing the generated front background image and the synthesized image to generate the space image.

11. A program for making a computer generate a space image including a moving body moving in a virtual three-dimensional space based on a given visual point, the program making the computer function as:
a moving body image generation unit for generating an image of the moving body as a moving body image based-on the visual point;
a rear image generation unit for generating an image of the virtual three-dimension space in a rear of the moving body as seen from the visual point as a rear background image;
a front image generation unit for generating an image of the virtual three-dimensional space in a front of the moving body as seen from the visual point as a front background image;
a blur processing unit for performing blur processing to at least one image among the generated moving body image, the generated rear background image and the generated front background image; and
a space image generation unit for synthesizing the generated moving body image and the generated rear background image, and further for synthesizing the generated front background image and the synthesized image to generate the space image, wherein as to the image having received the blur processing by the blur processing unit among the rear background image, the moving body image and the front background image, the image having received the blur processing is synthesized with the other images.

12. An information storage medium capable of being read by a computer, the medium storing a program as claimed in any one of claims 1, 10 and 11.

13. An image generation apparatus for generating a space image including a moving body moving in a virtual three-dimensional space based on a given visual point, the apparatus comprising:
a visual point control unit for controlling the visual point according to a movement of the moving body so that the moving body is arranged at a predetermined position in the space image;
a background image generation unit for generating an image of the virtual three-dimensional space except for the moving body as a background image based on the visual point;
a blur processing unit for performing predetermined blur processing to the generated background image to generate a background blur image;
a moving body image generation unit for generating an image of the moving body based on the visual point; and
a space image generation unit for synthesizing the generated image of the moving body and the background blur image generated by the blur processing unit to generate the space image.

14. An image generation apparatus for generating a space image including a moving body moving in a virtual three-dimensional space based on a visual point a sight line direction and an arrangement position of which is previously set, the apparatus comprising:
a moving body image generation unit for generating an image of the moving body as a moving body image based on the visual point;
a blur processing unit for performing predetermined blur processing to the generated moving body image to generate a moving body blur image;
a rear background image generation unit for generating an image of the virtual three-dimensional space in a rear of the moving body as seen from the visual point as a rear background image;
a front background image generation unit for generating an image of the virtual three-dimensional space in a front of the moving body as seen from the visual point as a front background image; and
a space image generation unit for synthesizing the generated moving body blur image and the generated rear background image, and further synthesizing the generated front background image and the synthesized image to generate the space image.

15. An image generation apparatus for generating a space image including a moving body moving in a virtual three-dimensional space based on a given visual point, the apparatus comprising:
a moving body image generation unit for generating an image of the moving body as a moving body image based on the visual point;
a rear image generation unit for generating an image of the virtual three-dimensional space in a rear of the moving body as seen from the visual point as a rear background image;
a front image generation unit for generating an image of the virtual three-dimensional space in a front of the moving body as seen from the visual point as a front background image;
a blur processing unit for performing blur processing to at least an image among the generated moving body image, the generated rear background image and the generated front background image; and
a space image generation unit for synthesizing the generated moving body image and the generated rear background image, and further for synthesizing the generated front background image and the synthesized image to generate the space image, wherein as to the image having received the blur processing by the blur processing unit among the rear background image, the moving body image and the front background image, the image having received the blur processing is synthesized with the other images.
